(19) United States
(12) Patent Application Publication
(10) Pub. No.: US 2026/0110361 A1
(43) Pub. Date: Apr. 23, 2026

(54) DISCHARGE UNIT, DISCHARGE ARRANGEMENT AND FORCE TRANSMISSION ARRANGEMENT

(71) Applicants: ElringKlinger AG, Dettingen (DE); ElringKlinger Kunststofftechnik GmbH, Bietigheim-Bissingen (DE)

(72) Inventor: Uwe KOCH, Pliezhausen (DE)

(73) Assignees: ElringKlinger AG, Dettingen (DE); ElringKlinger Kunststofftechnik GmbH, Bietigheim-Bissingen (DE)

(21) Appl. No.: 19/424,400

(22) Filed: Dec. 18, 2025

Related U.S. Application Data
(63) Continuation of application No. PCT/EP2024/066851, filed on Jun. 17, 2024.

(30) Foreign Application Priority Data
Jun. 20, 2023 (DE) 10 2023 116 110.5
Jun. 20, 2023 (DE) 20 2023 103 402.0

(51) Int. Cl. F16J 15/3228; F16J 15/3212; F16J 15/3284

(52) U.S. Cl. CPC F16J 15/3228; F16J 15/3212; F16J 15/3284

(57) ABSTRACT

Discharge unit for arrangement on a movable force transmission element which extends along a longitudinal axis, e.g., for arrangement on a shaft of which the rotational axis forms the longitudinal axis, wherein either the discharge unit comprises: - an outer carrier element, and - a discharge element fastened to the outer carrier element and extending in the direction towards the longitudinal axis and/or extending radially inwardly, or the discharge unit comprises the following: - an inner carrier element and - a discharge element fastened to the inner carrier element and extending in the direction away from the longitudinal axis and/or extending radially outwardly.

### RELATED APPLICATION

This application is a continuation of international application No. PCT/EP2024/066851 filed on June 17, 2024 and claims the benefit of German applications No. 102023 116 110.5 and No. 202023 103 402.0 filed on June 20, 2023 which are incorporated herein by reference in their entirety and for all purposes.

### FIELD OF DISCLOSURE

The present invention relates to a discharge unit, which may be, for example, a sealing unit, a discharge arrangement, which may be, for example, a sealing arrangement, and a force transmission arrangement.

### BACKGROUND

The present invention addresses the problem of providing an efficient force transmission arrangement and components therefor with as little outlay as possible. In particular, the aim is to reduce the maintenance effort for systems with electric machines, e.g., the maintenance effort for fully or partially electrically driven vehicles, with as little outlay as possible.

### SUMMARY OF THE INVENTION

According to the invention, the problem is solved by the discharge unit according to the relevant independent claim.

The invention is based on the knowledge that induced wave currents can lead to premature failure of bearings, e.g., roller bearings. The induced wave currents can be wave currents induced by the frequency converter of electric motors. A discharge element can be used to discharge the currents in a targeted manner before they are discharged via the roller bearing.

It has been shown that, particularly at high circumferential speeds of more than 25 m/s, conventional discharge elements and discharge arrangements with integrated sealing functions are not entirely satisfactory in terms of discharge behavior and sealing behavior.

The discharge unit according to the invention is a discharge unit for arrangement on a movable force transmission element which extends along a longitudinal axis, e.g., for arrangement on a shaft of which the rotational axis forms the longitudinal axis.

The movable force transmission element may be a shaft. The longitudinal axis along which the movable force transmission element extends may be the rotational axis of the shaft.

The discharge unit either comprises the following:

an outer carrier element and

a discharge element fastened to the outer carrier element and extending in the direction of the longitudinal axis and/or radially inwardly.

Alternatively, the discharge unit comprises the following:

an inner carrier element and

a discharge element fastened to the inner carrier element and extending in the direction away from the longitudinal axis and/or radially outwardly.

If an element, e.g., the discharge element, is fastened to the outer or inner carrier element, this may mean that it is fixed directly or indirectly to the carrier element.

Direct fixing to the carrier element may mean, in particular, that there is physical contact between the element, e.g., the discharge element, and the carrier element at the transition from the carrier element to the element, e.g., the discharge element. The carrier element and the other element, e.g., the discharge element, may, for example, be designed as a single piece or a surface of the carrier element may be in physical contact with a surface of the element, e.g., the discharge element.

An indirect fixing to the carrier element may in particular mean that at least one further element, e.g., a retaining element, fixing element, and/or delimiting element, is arranged between the carrier element and the element, e.g., the discharge element.

The discharge element extending in the direction of the longitudinal axis and/or radially inwardly may also extend in the axial direction. The discharge element extending in the direction away from the longitudinal axis and/or radially outwardly may also extend in the axial direction.

The axial direction refers in particular to a direction parallel to the longitudinal axis.

Preferably, the outer carrier element can be positioned on the outer surface of the force transmission element in such a way that the carrier element does not touch the outer surface when the discharge unit is arranged on the force transmission element.

Preferably, the discharge element fastened to the outer carrier element can be brought into electrical contact with the outer surface of the force transmission element when the dissipation unit is arranged on the force transmission element.

Preferably, the inner carrier element can be fastened to an outer surface of the force transmission element when the discharge unit is arranged.

The carrier element may have at least one recess on a surface of the carrier element facing the outer surface. A fixing element may be located in the at least one recess, which can be fastened to the outer surface of the force transmission element.

The at least one recess may be at least one radially circumferential recess. The fixing element may be an annular fixing element, e.g., an O-ring, which may be located in the at least one annularly circumferential recess. The annular fixing element can also have a static sealing effect, which can counteract the transfer of lubricant, e.g., oil, between the outer surface of the force transmission element and the inner carrier element when the inner carrier element is fastened to an outer surface of the force transmission element after the discharge unit has been installed. The annular fixing element, e.g., the O-ring, can act as a secondary static sealing element.

Preferably, the discharge element fastened to the inner carrier element can be brought into electrical contact with an inner surface of a contact element when the discharge unit is arranged on the force transmission element.

The contact element may be a component, e.g., a machine element. The component, e.g., the machine element, may have a recess. The inner surface may be an inner surface of the recess. The inner surface may preferably be a cylindrical inner surface of the recess.

The electrical contact may in particular be a sliding contact.

The term "in particular" is used in this description and the accompanying claims to describe possible optional and/or alternative features.

The carrier element, e.g., the outer or inner carrier element, is preferably annular.

The carrier element may have a ring portion and a disc portion.

It may be advantageous if

the ring portion has a smaller extent in the radial direction than in the axial direction and the disc portion has a smaller extent in the axial direction than in the radial direction;

and/or;

the ring portion is parallel or inclined to the axis of the carrier element and the disc portion is orthogonal or inclined to the axis of the carrier element,

wherein, if the ring portion is inclined,

an inclination of the ring portion to the axis of the carrier element is not greater than an inclination of the disc portion to the axis of the carrier element

or

the disc portion is orthogonal to the axis of the carrier element.

Extents and inclinations of the ring portion and the disc portion can be determined in at least one profile of the carrier element on one side of the axis, wherein the at least one profile of the carrier element is a profile of the carrier element obtainable by an axial section.

For example, the ring portion may be wholly or partially hollow cylindrical or conical. The inclination of the ring portion relative to the axis of the carrier element may result from a wholly or partially conical shape of the ring portion.

For example, the disc portion may be annular.

It may be advantageous if the disc portion of the outer carrier element merges into the ring portion at a radially outer end of the disc portion.

It may be advantageous if the disc portion of the inner carrier element merges into the ring portion at a radially inner end of the disc portion.

The axis of the carrier element coincides with the longitudinal axis when the discharge unit is arranged on the movable force transmission element.

The axis of the carrier element coincides with the rotational axis when the discharge unit is arranged on the shaft.

The discharge unit may preferably comprise either of the following:

a delimiting element fastened to the outer carrier element, extending in the direction of the longitudinal axis and/or radially inwardly, which, when the discharge unit is arranged on the force transmission element, separates a first zone of the outer surface of the force transmission element from a second zone of the outer surface of the force transmission element. The first zone of the outer surface may, for example, be a lubrication zone. The second zone of the outer surface may, for example, be a discharge contact zone. In the discharge contact zone, the discharge element may be brought into electrical contact with the outer surface of the force transmission element when the discharge unit is arranged on the force transmission element.

Alternatively, the discharge unit may preferably comprise the following:

a delimiting element fastened to the inner carrier element, extending in the direction away from the longitudinal axis and/or radially outwardly, which, when the discharge unit is arranged on the force transmission element, delimits a first zone of the inner surface of a

surrounding contact element from a second zone of the inner surface of the contact element. The first zone of the inner surface may, for example, be a lubrication zone. The second zone of the inner surface may, for example, be a discharge contact zone. In the discharge contact zone, the discharge element may be brought into electrical contact with the inner surface of the surrounding contact element when the discharge unit is arranged on the force transmission element.

Preferably, when the discharge unit is arranged on the force transmission element, the delimiting element can be brought into contact either with the outer surface of the force transmission element or with the inner surface of the contact element. The term "brought into contact" may refer in particular to physical contact. This does not exclude the possibility that physical contact with the outer surface of the force transmission element or with the inner surface of the contact element may be established via a lubricant or a lubricant layer, if present.

The delimiting element may be or comprise a textile sheet material.

If the discharge unit comprises the outer carrier element, the textile sheet material may preferably extend to the outer surface of the force transmission element when the discharge unit is arranged on the force transmission element, or, if the discharge unit comprises the inner carrier element, to the inner surface of the surrounding contact element. The delimiting element may preferably be the textile sheet material.

The textile sheet material may preferably be an irregular textile sheet material, for example a nonwoven fabric or felt, in particular a nonwoven fabric. This can be advantageous because it allows any abrasion of the discharge element to essentially only reach the delimiting element in a structurally simple manner. This can help to keep the abrasion away from seals, which may be arranged, for example, on roller bearings, or from electronic components, which may be used, for example, to control a motor vehicle. Consequently, maintenance costs can be reduced, resulting in the desired increases in efficiency.

The delimiting element may preferably be a sealing element. The sealing element may, for example, be an annular sealing element.

The discharge unit may, for example, be a sealing unit.

The sealing unit may preferably enable a discharge effect mediated by the discharge element and a sealing effect mediated by the sealing element.

The sealing unit may in particular be a radial shaft seal unit, e.g., a radial shaft seal ring.

The delimiting element, e.g., the sealing element, may be a turned delimiting element, e.g., a turned sealing element. It may be obtained wholly or partly by turning.

The delimiting element, e.g., the sealing element, may be a shaped delimiting element, e.g., a shaped sealing element. It may be obtained wholly or partly by molding, e.g., primary molding or secondary molding.

The delimiting element, e.g., the sealing element, may contain a plastic or be made of a plastic, e.g., by turning from a plastic semi-finished product or by primary forming from a plastic melt.

It may be advantageous if the sealing element, e.g., the annular sealing element, has a sealing surface.

When the discharge unit, e.g., the sealing unit, is arranged on the force transmission element, the sealing surface is to lie on the outer surface of the force transmission element. This applies in particular if the delimiting element is a sealing element fastened to the outer carrier element and extending in the direction of the longitudinal axis and/or radially inwardly. The sealing surface, which is to be located on the outer surface, is preferably movable relative to the outer surface, e.g., movable relative to the outer surface by rotation. The sealing contact between the sealing surface and the outer surface can be a dynamic sealing contact.

When the discharge unit, which is, for example, the sealing unit, is arranged on the force transmission element, the sealing surface is to be located on the inner surface of the surrounding contact element. This applies in particular if the delimiting element is a sealing element fastened to the inner carrier element and extending in the direction away from the longitudinal axis and/or radially outwardly. The sealing surface to be located on the inner surface is preferably movable relative to the inner surface, e.g., movable by rotation relative

to the inner surface. The sealing contact between the sealing surface and the inner surface may be a dynamic sealing contact.

It may be advantageous if the sealing surface has a lubricant retention structure. A lubricant retention structure is understood to be, in particular, a structure which can counteract undesirable leakage of lubricant in the area of the dynamic sealing contact. Preferably, the lubricant retention structure in the area of the dynamic sealing contact can counteract undesirable leakage of lubricant at least in one direction of rotation of the force transmission element, e.g., the shaft.

The lubricant retention structure may comprise a swirl structure.

Preferably, a spiral groove can be formed in the sealing surface.

Preferably, the spiral groove can be a first spiral groove and a second spiral groove can be formed in the sealing surface.

The spiral groove may wind radially outwardly from the longitudinal axis in one direction. The first spiral groove may wind radially outwardly from the longitudinal axis in a first direction. The second spiral groove may wind radially outwardly from the longitudinal axis in an opposite second direction. This applies in particular if the delimiting element is a sealing element fastened to the outer carrier element and extending in the direction towards the longitudinal axis and/or radially inwardly.

The spiral groove can wind radially inwardly in one direction relative to the longitudinal axis. The first spiral groove can wind radially inwardly in a first direction relative to the longitudinal axis. The second spiral groove can wind radially inwardly in the direction towards the longitudinal axis in an opposite second direction. This applies in particular if the delimiting element is a sealing element fastened to the inner carrier element and extending in the direction away from the longitudinal axis and/or radially outwardly.

The spiral groove can define at least one full spiral turn in one direction around the longitudinal axis.

Preferably, the first spiral groove and the second spiral groove can each define at least one full spiral turn in a first and second direction around the longitudinal axis, wherein the spiral grooves are arranged in a staggered manner so that at least one turn of the first spiral groove intersects with at least one turn of the second spiral groove.

The spiral grooves may have the same pitch angle.

The spiral grooves may have different pitch angles.

The interfaces between the first and second spiral grooves may define a plurality of intersection points arranged in a plane in which the longitudinal axis lies.

The spiral grooves may have the same contact angle relative to a circle centered on the longitudinal axis, which is less than 1 degree.

The first and second spiral grooves may have connected ends, whereby the spiral grooves form a continuous channel.

The radial distance between the turns of each spiral groove may be at least twice as large, e.g., at least ten times as large, as the width of each spiral groove.

The width of each spiral groove may preferably be no more than 0.05 mm.

It has been found that, in conjunction with the invention, the at least one spiral groove can be used to further reduce the maintenance requirements for systems with electric machines, e.g., the maintenance requirements for fully or partially electrically powered vehicles.

This is likely to be due to the fact that electrical contact can be maintained particularly reliably in the transition from the discharge element to the outer surface or inner surface if the spiral groove counteracts the transfer of lubricant into this area.

The discharge element is preferably annular.

Preferably, the discharge element may comprise at least one discharge contact area extending in the direction of the longitudinal axis and/or radially inwardly, which can be brought into electrical contact with the outer surface of the force transmission element when the discharge unit is arranged on the force transmission element. Preferably, the discharge element may alternatively comprise at least one discharge contact area extending in the direction away from the longitudinal axis and/or radially outwardly, which can be brought into electrical contact with the inner surface of the contact element when the discharge unit is arranged on the contact element.

Preferably, when the discharge unit is arranged on the force transmission element, the discharge element, in particular the at least one discharge contact area of the discharge element, can be reshaped, elastically deformed, and/or prestressed by a movement parallel to a plane, e.g., a prestress plane. Alternatively, when arranging the discharge unit on the contact element, the discharge element, in particular the at least one discharge contact area of the discharge element, can preferably be reshaped, elastically deformed and/or prestressed by a movement parallel to a plane, e.g., a prestress plane.

Preferably, the longitudinal axis can lie in the plane, e.g., in the prestress plane, or intersect the plane, e.g., the prestress plane, at an angle of at most 15°, in particular at most 5°.

Preferably, the longitudinal axis can intersect the plane, e.g., the prestress plane, at an angle of 75° to 90°, in particular 85° to 90°.

The discharge element may preferably comprise several discharge contact areas spaced apart from one another. Preferably, the multiple discharge contact areas of the discharge element, which are spaced apart from one another, can be brought into electrically conductive contact with the outer surface of the force transmission element or with the inner surface of the contact element when the discharge unit is arranged on the force transmission element.

It may be advantageous if the discharge element extends further inward in the discharge contact area or discharge contact areas in the direction of the longitudinal axis and/or radially inwardly than in an area adjacent to a discharge contact area or than in an intermediate area of the discharge element located between several discharge contact areas, if the discharge element extends in the direction towards the longitudinal axis and/or radially inwardly. At least one discharge element of the discharge element may extend in the direction towards each discharge contact area, wherein each discharge element occupies a discharge area. The discharge area of each discharge element preferably amounts to 1% to 10% of a recess area surrounded by the discharge element into which the discharge elements protrude. A preferred discharge element can be described by two circles of which the centers coincide. An inner circle has radius r1. An outer circle has radius r2. Radius r1 corresponds to the distance of the discharge contact areas from the center point. Radius r2 is chosen such that the area of the outer circle corresponds to the recess area. Preferably, the ratio of r1 to r2 is 0.2 to 0.99, particularly preferably 0.25 to 0.97, e.g., 0.3 to 0.95. Preferably, the discharge surfaces, the recess area, the circles, and their radii r1 and r2 are determined in a basic state, e.g., a flat basic state, in which the deflection element is present when it is not arranged on a force transmission element and is also not formed, elastically deformed, and/or prestressed by means of an inclined alignment portion.

It may be advantageous if the discharge element extends further outward in the discharge contact area or discharge contact areas in the direction away from the longitudinal axis and/or radially outwardly than in an area adjacent to a discharge contact area or than in an intermediate area of the discharge element located between several discharge contact areas, if the discharge element extends away from the longitudinal axis and/or radially outwardly.

It can be particularly advantageous if the discharge element extends further inward in the discharge contact areas in the direction of the longitudinal axis and/or radially inwardly than in the intermediate areas of the discharge element lying between these discharge contact areas, if the discharge element extends in the direction of the longitudinal axis and/or radially inwardly.

It can be particularly advantageous if the discharge element extends further outward in the discharge contact areas away from the longitudinal axis and/or radially outwardly than in the intermediate areas of the discharge element located between these discharge contact areas, if the discharge element extends away from the longitudinal axis and/or radially outwardly.

Preferably, the discharge element may comprise two to thirty discharge contact areas spaced apart from one another. Particularly preferably, the discharge element may comprise two to twenty discharge contact areas spaced apart from one another. The discharge element may, for example, comprise two to twelve discharge contact areas spaced apart from one another. It may be particularly advantageous if the discharge element comprises three to eight discharge contact areas spaced apart from one another.

It may be advantageous if the discharge unit either comprises the following:

the outer carrier element,

the discharge element fastened to the outer carrier element and extending in the direction of the longitudinal axis and/or radially inwardly, and

the delimiting element fastened to the outer carrier element, extending in the direction of the longitudinal axis and/or radially inwardly, which, when the discharge unit is arranged on the force transmission element, demarcates the first zone of the outer surface of the force transmission element from the second zone of the outer surface of the force transmission element, wherein it may be advantageous if the delimiting element is or comprises the textile sheet material,

wherein it may be advantageous if the discharge element comprises a plurality of discharge contact areas spaced apart from one another, wherein the plurality of discharge contact areas of the discharge element spaced apart from one another can be brought into electrically conductive contact with the outer surface of the force transmission element when the discharge unit is arranged on the force transmission element;

or the discharge unit comprises:

the inner carrier element,

the discharge element fastened to the inner carrier element and extending in the direction away from the longitudinal axis and/or radially outwardly, and

the delimiting element fastened to the inner carrier element, extending in the direction away from the longitudinal axis and/or radially outwardly, which, when the discharge unit is arranged on the force transmission element, demarcates the first zone of the inner surface of the surrounding contact element from the second zone of the inner surface of the contact element, wherein it may be advantageous if the delimiting element is or comprises the textile sheet material,

wherein it may be advantageous if the discharge element comprises a plurality of discharge contact areas spaced apart from one another, wherein the plurality of discharge contact areas of the discharge element spaced apart from one another can be brought into electrically conductive contact with the inner surface of the contact element when the discharge unit is arranged on the force transmission element.

It may be advantageous if the discharge element is a first discharge element and the delimiting element or a further discharge element comprised in the discharge unit is a second discharge element.

The second discharge element and the first discharge element may preferably extend in the same direction.

Preferably, the first and second discharge elements may each be a discharge element extending in the direction towards the longitudinal axis and/or radially inwardly. Preferably, when the discharge unit is arranged on the force transmission element, the first and second discharge elements can be brought into electrical contact with the outer surface of the force transmission element.

Preferably, the first and second discharge elements may each be a discharge element extending in the direction away from the longitudinal axis and/or radially outwardly. Preferably, when the discharge unit is arranged on the force transmission element, the first and second discharge elements may be brought into electrical contact with the inner surface of the surrounding contact element.

The electrical contact of the first and second discharge elements to the outer surface may preferably comprise a direct electrical contact of the first discharge element to the outer surface and a direct electrical contact of the second discharge element to the outer surface.

The electrical contact of the first and second discharge elements to the inner surface may preferably comprise direct electrical contact of the first discharge element to the inner surface and direct electrical contact of the second discharge element to the inner surface.

It may be advantageous if one discharge element, e.g., the second discharge element, differs from the first discharge element in at least one of the following characteristics:

electrical conductivity,

contact pressure on the inner surface or on the outer surface,

composition, wherein the second discharge element and/or the first discharge element may preferably be or comprise a composite element,

shape.

It is preferable if the second discharge element and the first discharge element are each a composite element or each comprise a composite element and the electrical conductivity, the contact pressure on the inner surface or on the outer surface, the compositions of the two composite elements and/or the shape of the two composite elements differ.

The use of at least two different discharge elements can offer significant technical advantages. For example, by selecting the specified characteristics, one of the discharge elements can be designed so that reliable discharge can be ensured under one operating condition (e.g., at a particularly high shaft speed, in the event of a lubricant shortage, and/or at a particularly high temperature), and the other discharge element can be designed so that reliable discharge can be ensured under another operating condition (e.g., at particularly low shaft speeds, in the event of excess lubricant and/or at particularly low temperatures), and thus the voltage that builds up between components can always be reliably dissipated and, to the greatest possible extent, independently of the operating condition , so that bearing damage caused by electrical erosion can be reduced to a minimum or almost completely avoided.

It can be advantageous if the at least one discharge contact area of the first discharge element is at least one first discharge contact area and the second discharge element comprises at least one second discharge contact area, wherein the first and second discharge contact areas both extend either

in the direction towards the longitudinal axis and/or radially inwardly

or

extend away from the longitudinal axis and/or radially outwardly.

It can be particularly advantageous if the multiple discharge contact areas of the first discharge element are multiple first discharge contact areas and the second discharge element comprises multiple second discharge contact areas. Preferably, the first and second discharge contact areas can all extend

in the direction towards the longitudinal axis and/or radially inwardly

or

extend away from the longitudinal axis and/or radially outwardly.

It can be advantageous for at least one intermediate area of a discharge element to overlap at least partially with a discharge contact area of a further discharge element.

Advantageously, at least one first intermediate region of the first discharge element may overlap with a discharge contact area of the second discharge element, e.g., with the second discharge contact area.

Preferably, several intermediate regions of a discharge element may at least partially overlap with one of several contact areas of a further discharge element.

The aforementioned overlap may preferably be an overlap observable when viewed along the longitudinal axis.

It may be advantageous if the discharge unit comprises a pressing element with which at least one discharge element of the discharge unit, e.g., a discharge contact area of the discharge element, can be pressed onto the outer surface of the force transmission element when the discharge unit is arranged on the force transmission element.

to the outer surface of the force transmission element or

pressed onto the inner surface of the contact element.

In particular, the pressing element can be used to reinforce electrical contact between the discharge element and the outer surface or the inner surface.

The pressing element can be fastened to the carrier element.

The pressing element may preferably comprise a spring element or a plastic element.

The spring element may be, for example, a spring plate.

The plastic element may preferably comprise a polymer layer, e.g., a polymer film or a polymer plate.

Depending on the application, any polymers that can be provided in the form of a film may be suitable as a polymer film.

The temperature resistance of the plastic element may preferably be at least 150 °C.

The polymer layer may preferably contain a polymer containing ketone groups or be formed therefrom. The polymer containing ketone groups may, for example, comprise a polyether ether ketone (PEEK), a polyether ketone (PEK), and/or a polyketone (PK).

The polymer layer may contain elastomers, e.g., FKM, NBR, EPDM, or be formed therefrom.

The polymer layer may contain at least one thermoset, preferably a thermoset-containing film, e.g., adhesive film TESA HAF 8400, or be formed therefrom.

The pressing element may be present in a laminate with the or at least one discharge element.

The pressing element and the discharge element may be present as a composite film.

The pressing element may preferably be an annular pressing element.

A pressing projection of the pressing element may extend to a discharge contact area of the discharge element.

It may be advantageous if a contact force measurable orthogonally to the outer surface of the force transmission element, with which a discharge element can be held in electrical contact with the outer surface of the force transmission element when the discharge unit is arranged on the force transmission element, at least 15 mN, preferably 15 mN to 20 N, particularly preferably 22 mN to 14 N, when a smallest inner diameter of the discharge element is increased by one millimeter starting from a non-prestressed basic state of the discharge element when the discharge unit is arranged on the force transmission element.

Alternatively, it is advantageous if a contact force measurable orthogonally to the inner surface of the contact element, with which a discharge element can be maintained in electrical contact with the inner surface of the contact element when the discharge unit is arranged on the contact element, reaches at least 10 mN, preferably 10 mN to 20 N, particularly preferably 15 mN to 14 N, when a largest outer diameter of the discharge

element is reduced by one millimeter starting from a non-prestressed basic state of the discharge element when the discharge unit is arranged on the contact element.

The discharge unit may have an inclined alignment portion.

It may be advantageous if at least one discharge element and/or at least one delimiting element and/or at least one sealing element is reshaped, elastically deformed, and/or prestressed by means of an inclined alignment portion of the discharge unit.

When reference is made herein to an inclined alignment portion, this preferably means a truncated cone-shaped alignment portion.

The inclined alignment portion can serve to reshape, elastically deform, and/or prestress at least one deflection element.

The inclined alignment portion can be used to reshape, elastically deform, and/or prestress at least one delimiting element.

The inclined alignment portion can be used for reshaping, elastic deformation, and/or prestressing of the at least one sealing element.

It is preferable if the at least one discharge element and/or the at least one delimiting element and/or the at least one sealing element is formed, elastically deformed and/or prestressed by means of an inclined alignment portion of the discharge unit and by means of the pressing element.

It is preferable if the at least one deflection element and/or the at least one delimiting element and/or the at least one sealing element is reshaped, elastically deformed and/or prestressed between an inclined alignment portion and the pressing element.

It may be advantageous if at least one discharge element is a composite element or comprises a composite element, wherein the composite element comprises a discharge material and a reinforcing material.

Advantageously, in one, several, or each composite element described herein, the discharge material and the reinforcing material may be connected to each other in any manner. "Composite" means " combination," without making any statement about the type of combination existing. Depending on the geometry of the combination, composite materials may be understood to include, for example: Particle composites, also known as particle composites or dispersion materials, fiber composites with short fibers, long fibers, or continuous fibers, layered composites, also known as laminates, e.g., in sandwich form, interpenetrating composites, structural composites. The components of a composite material can themselves be composites. In principle, all conceivable forms of the combination of discharge material and reinforcing material are possible for one or every composite element described herein.

Any sufficiently electrically conductive material that is suitable for effecting a constant charge balance between device elements is suitable as a discharge material. The discharge material can be, in particular, an electrically conductive metal or an electrically conductive non-metal, e.g., a carbon material.

Any material that can be used to reinforce the discharge material is suitable as a reinforcing material. The reinforcing material can, for example, make it more difficult to bend the dissipative material or make it more difficult to deform the dissipative material, in particular if the dissipative material comprises one or more thin metal strands. The reinforcing material can, for example, make it more difficult to break the dissipative material, in particular if the dissipative material is a carbon material, e.g., graphite.

Advantageously, the discharge material and the reinforcing material can together form a particle composite material. For example, the discharge material can be a discharge material that is wholly or partially distributed in the reinforcing material and is particulate, e.g., powdery and/or particulate. In particular, the reinforcing material can impart shape and strength to the particulate discharge material by embedding at least some or all of the particles of the particulate discharge material in the reinforcing material. The reinforcing material can form a matrix material of the particulate composite material.

The reinforcing material may be, for example, a plastic reinforcing material.

The plastic reinforcing material may be, for example, a thermosetting material, an elastomeric material, or a thermoplastic material.

The thermosetting material may preferably contain a resin, e.g., an epoxy resin or a phenolic resin. It is also possible that the thermosetting material contains a hybrid resin system.

It may be particularly preferred if the plastic reinforcing material is not meltable at a temperature of up to 180°C, preferably up to 210°C, e.g., up to 230°C.

If the plastic reinforcing material is a thermosetting material or an elastomeric material, the plastic reinforcing material is not meltable anyway and therefore also not meltable at a temperature of up to 180 °C, preferably up to 210 °C, e.g., up to 230 °C.

If the plastic reinforcing material is a thermoplastic material, it may also be non-meltable at a temperature of up to 180°C, preferably up to 210°C, e.g., up to 230°C. Thermoplastic materials with correspondingly high melting points are known to those skilled in the art.

Preferably, the plastic reinforcing material may contain at least

a polymer containing keto groups, e.g., a polyetheretherketone (PEEK), a polyetherketone (PEK), and/or a polyketone (PK); and/or

a polymer containing imido groups, e.g., a polyamideimide (PAI), a polyetherimide (PEI), and/or a polyimide (PI); and/or

a polymer containing amide groups, e.g., a polyphthalamide (PPA) and/or a polyamide (PA); and/or

a polymer containing sulfide bridges, e.g., a polyphenylene sulfide (PPS), and/or;

a polymer containing sulfone groups, e.g., a polysulfone (PSU); and/or

a fluoropolymer, preferably a melt-processable fluoropolymer, e.g., a melt-processable perfluoroalkoxy polymer (PFA); and/or

a liquid crystalline polyester.

In particular, the plastic reinforcing material may preferably contain at least

a polymer containing keto groups, e.g., a polyetheretherketone (PEEK), a polyetherketone (PEK) and/or a polyketone (PK); and/or

a polymer containing imido groups, e.g., a polyamideimide (PAI), a polyetherimide (PEI), and/or a polyimide (PI); and/or

a polymer containing amide groups, e.g., a polyphthalamide (PPA) and/or a polyamide (PA); and/or

a polymer containing sulfide bridges, e.g., a polyphenylene sulfide (PPS), and/or;

a polymer containing sulfone groups, e.g., a polysulfone (PSU); and/or

a liquid crystalline polyester.

Preferably, the plastic reinforcing material may contain a non-melt-processable polymer, preferably a non-melt-processable fluoropolymer, e.g., polytetrafluoroethylene (PTFE).

Common abbreviations for the polymers mentioned are given between parentheses.

The plastic reinforcing material may contain a plastic matrix material and a filler different from the discharge material, wherein, for example, one or more of the polymers or resins mentioned may form the plastic matrix material.

The term "filler" refers in particular to all materials dispersed as particles or fibers in the plastic matrix material which do not form the discharge material.

It may be advantageous if the filler

a friction-reducing material, which may be preferably selected from boron nitride, molybdenum disulfide, non-ferrous metals, e.g., aluminum, copper, lead, indium, or tin, ceramics, e.g., titanium nitride, and plastics, e.g., PTFE;

and/or

a wear-reducing polymeric material, wherein the wear-reducing polymeric material is preferably selected from an aramid, a polyimide (PI), a polyphenylene sulfone (PPSU), a polyether ether ketone (PEEK), an ultra-high molecular weight polyethylene (PE-UHMW), and a fully aromatic polyester.

The abbreviations commonly used for the polymers mentioned are given between parentheses. The PPSU may, for example, be a PPSU marketed under the name Ceramer. The fully aromatic polyester may, for example, be a polyester marketed under the name Sumica Super or under the name Ekonol.

Certain discharge materials, in particular graphite particles, can have a friction-reducing effect. Consequently, the addition of a further friction-reducing material may be dispensable.

Advantageously, the filler may contain fibers, wherein the fibers may preferably be mineral fibers and/or polymer fibers and/or carbon fibers, wherein the mineral fibers may preferably be glass fibers and the polymer fibers may preferably be amide fibers or partially oxidized polyacrylonitrile fibers, wherein the amide fibers may preferably be aramid fibers.

Advantageously, the filler may contain a mineral material. For example, the mineral material may contain wollastonite and/or mica.

It can be advantageous if the mass fraction of the discharge material in the composite element or particle composite material is 25 to 55 wt.%, preferably 30 to 50 wt.%, e.g., 35 to 45 wt.%.

It may be advantageous if graphite particles serve as the discharge material or form a component of the discharge material and the mass fraction of graphite particles in the composite element or particle composite material is 25 to 55 wt.%, preferably 30 to 50 wt.%, e.g., 35 to 45 wt.%.

It may be particularly advantageous if the dissipative material is metal wool and the reinforcing material is a plastic and/or the plastic reinforcing material.

The metal wool may be arranged in the plastic such that the metal wool is not completely surrounded by the plastic and/or the plastic reinforcing material.

The metal wool preferably extends at two ends of the composite element to the surfaces of the composite element. This can increase the electrical conductivity of the composite element.

Preferably, the metal wool is compacted in at least one direction, and the plastic holds the compacted metal wool in a compacted state.

Preferably, the plastic may be present as a plastic matrix and the metal wool may be embedded in the plastic matrix.

The plastic may advantageously contain a resin and/or a fluoropolymer.

The resin may be a partially or completely synthetic resin. The resin may preferably be a phenolic resin, an epoxy resin (e.g., SKresin 3210), a polyurethane resin, a silicone resin, a vinyl ester resin, or an acrylic resin. It may be, for example, a phenolic resin. Preferably, the resin does not contain any fluoropolymers and/or any organofluorine substances.

The term "fluoropolymer" refers to a polymer that contains fluorine atoms bonded to carbon atoms. The fluoropolymer may preferably be a polytetrafluoroethylene (PTFE), a perfluoroalkoxy polymer (PFA), a polyvinyl fluoride (PVF), a polyvinylidene fluoride (PVDF), a polychlorotrifluoroethylene (PCTFE), ethylene tetrafluoroethylene (ETFE), perfluoro(ethylene-propylene) (FEP), or fluororubber, e.g., PTFE or PFA.

It may be advantageous if the dissipative material comprises or is a carbon material. The carbon material may be graphite, graphene, graphene oxide, or carbon fiber, e.g., graphite. The graphite may contain natural graphite, synthetic graphite, and/or expanded graphite.

It may be advantageous if the dissipative material, e.g., the carbon material, is dispersed in the reinforcing material, e.g., plastic reinforcing material.

The carbon material, e.g., the graphite, can be arranged on the reinforcing material, wherein the reinforcing material can preferably be a metallic reinforcing material, e.g., a metal mesh, metal wool, or metal foil.

The carbon material, e.g., graphite, may be present in a layered composite with the reinforcing material.

The carbon material may comprise a graphite foil. The graphite foil may be present in a layered composite with the reinforcing material.

The composite element may be obtained by punching from a precursor element, wherein the precursor element comprises the discharge material and the reinforcing material.

The composite element may be obtained by pressing, e.g., powder pressing, from a precursor material, wherein the precursor material comprises the discharge material and the reinforcing material or a precursor material of the reinforcing material.

Preferably, the composite element may be strand-shaped or strip-shaped.

The composite element may be, for example, a composite spring element. Preferably, the composite spring element may be strand-shaped or strip-shaped, in particular strip-shaped.

This can be advantageous because, when used as a contact element of a discharge element, the composite spring element can rest against the surface contact zone of the device element in a prestressed state. This can promote reliable electrical contact. The strip or strand shape is suitable for this purpose.

It may be advantageous if the reinforcing material comprises two plastic layers and the dissipative material extends between the two plastic layers. The plastic layers may be adhesive films. The adhesive films may preferably be thermosetting adhesive films. The dissipative material extending between the plastic layers may preferably be a metallic dissipative material. The metallic dissipative material may preferably comprise elongated metal elements, e.g., wires or strands. It may be particularly preferable for the dissipative material extending between the plastic layers to be metal wool, e.g., copper wool, wherein the metal wool, e.g., the copper wool, may be compacted orthogonally to the two layer planes of the two plastic layers.

It may be advantageous if the dissipative element contains an electrically conductive polymer and/or is made of an electrically conductive polymer.

The electrically conductive polymer may be, for example, polyaniline (PANI).

In particular, if the at least one discharge element is the composite element or comprises the composite element, the discharge unit may comprise the pressing element with which the at least one discharge element of the discharge unit, e.g., a discharge contact area of the discharge element, can be pressed against the outer surface or inner surface when the discharge unit is arranged on the force transmission element.

It has been found in particular that, in composite elements with discharge materials extending between plastic layers, contact forces can decrease and this can be compensated for with minimal effort by using one or more of the pressing elements described herein.

It may be advantageous if the discharge unit comprises the following:

the delimiting element extending in the direction of the longitudinal axis and/or radially inwardly, which represents a first delimiting element, and

a second delimiting element, which also extends in the direction of the longitudinal axis and/or radially inwardly,

or if the discharge unit comprises:

the delimiting element extending in the direction away from the longitudinal axis and/or radially outwardly, which represents a first delimiting element, and

a second delimiting element which also extends away from the longitudinal axis and/or radially outwardly,

The second delimiting element, which also extends in the direction towards the longitudinal axis and/or radially inwardly, can, when the discharge unit is arranged on the force transmission element, delimit the second zone of the outer surface of the force transmission element, which can be, for example, the discharge contact zone, from a third zone of the outer surface of the force transmission element.

The second delimiting element, which also extends away from the longitudinal axis and/or

or radially outwardly, can, when the discharge unit is arranged on the force transmission element, delimit the second zone of the inner surface of the contact element, which may be, for example, the discharge contact zone, from a third zone of the inner surface of the contact element.

It may be advantageous if the two delimiting elements, the first delimiting element and the second delimiting element, are sealing elements.

It may be advantageous if the outer carrier element has a receiving zone. The receiving zone may preferably extend into a receiving recess. The receiving recess may be a receiving recess extending radially outwardly into the outer carrier element.

The discharge unit may comprise a fixing element that can be at least partially received in the receiving recess. The fixing element can be at least partially accommodated in the receiving recess. By means of the fixing element, at least the discharge element, e.g., at least the first discharge element, and/or at least the delimiting element, e.g., at least the first delimiting element, and/or at least the sealing element, e.g., at least the first sealing element, can be fastened to the outer carrier element.

The discharge unit may comprise a retaining element. The retaining element may preferably be arranged on the delimiting element, e.g., sealing element. It may be particularly advantageous when the retaining element is arranged between the fixing element and the delimiting element.

The retaining element may preferably exert a static sealing effect and act as a secondary static sealing element.

The retaining element may preferably counteract the transfer of lubricant from a lubrication zone through the receiving zone into the discharge contact zone.

The discharge unit may comprise a separation element.

A separation element, e.g., the separation element comprised in the discharge unit, may be arranged between the discharge element, e.g., the first discharge element, and the delimiting element, e.g., the first delimiting element. The separation element may be arranged between a section of the delimiting element fastened to the carrier element and a section of the discharge element fastened to the carrier element. The separation element may be arranged between a section of the delimiting element fastened to the outer carrier element and a section of the discharge element fastened to the outer carrier element.

The discharge elements, delimiting elements, sealing elements, and separation elements described herein may be components connected to each other by force. They may be

pressed against each other directly or indirectly with the fixing element in the receiving recess of the outer carrier element and thereby connected to each other by force.

The separation element can separate the discharge element, e.g., the first discharge element and/or the second discharge element, from the delimiting element, e.g., from the first and/or the second delimiting element.

The separation element can separate the discharge element, e.g., the first discharge element and/or the second discharge element, from the sealing element, e.g., from the first and/or the second sealing element.

The separation element may have an inclined alignment portion, wherein the alignment portion of the separation element may preferably be a sealing element alignment portion with which the sealing element, e.g., the first and/or second sealing element, is formed, elastically deformed, and/or prestressed.

The separation element may have a separation portion. The alignment portion of the separation element, e.g., the sealing element alignment portion, may preferably run at an incline starting from the separation portion.

The separation portion may preferably be arranged radially further out than the alignment portion, e.g., than the sealing element alignment portion.

At least part of a sealing element alignment portion may abut a surface of a sealing element, whereby the sealing element may be reshaped, elastically deformed, and/or prestressed.

Preferably, at least part of a sealing element alignment portion may extend spaced apart from the discharge element in the direction towards the outer surface of the force transmission element or in the direction towards the inner surface of the contact element.

The separation element may consist of multiple parts. It may comprise at least one first separation component and at least one second separation component.

It may be advantageous if the first separation component has the alignment portion, e.g., the sealing element alignment portion.

The first separation component, which has the alignment portion, e.g., the sealing element alignment portion, can be a deep-drawn separation component obtained by deep drawing.

A material thickness of the first separation component in the area of the alignment portion, e.g., the sealing element alignment portion, may preferably be 50% to 150% of a material thickness in the area of a radial extent portion of the first separation component adjacent to the alignment portion, e.g., the sealing element alignment portion.

It may be advantageous if the material thickness of the second separation component is greater, preferably at least 60% greater, particularly preferably at least 110% greater, e.g., at least 225% greater, than the material thickness of the first separation component.

It may be advantageous if a material thickness of the second separation component measurable in the direction of the longitudinal axis is greater, preferably at least 60% greater, particularly preferably at least 110% greater, e.g., at least 225% greater, than a material thickness of the first separation component measurable in the direction of the longitudinal axis.

It may be advantageous if a smallest inner diameter of the second separation component is greater than a smallest inner diameter of the alignment portion, e.g., the sealing element alignment portion.

The separation element may have a separation portion formed radially outside the alignment portion, e.g., the sealing element alignment portion.

The separation portion may be formed by the second separation component and the radially extending section of the first separation component.

The separation element, the first separation component, and/or the second separation component may be manufactured by metal powder injection molding.

The elements described, e.g., discharge elements, delimiting elements, sealing elements, and/or separation elements, or a part of the elements described, may represent areas of a body.

Preferably, the discharge element and the delimiting element can extend from an outlet zone of the discharge unit, wherein it is preferable if at least part of the discharge element, at least part of the delimiting element and at least part of the outlet zone are formed by an electrically conductive body containing at least one discharge material.

The body can, for example, function as the carrier element or be arranged on the carrier element, for example.

For example, at least part of the second delimiting element may also be formed by the body.

Advantageously, the body may be a composite body comprising a discharge material and a bonding material, wherein it may be preferred if the discharge material is embedded in the bonding material.

The connecting material may, for example, be a reinforcing material as described herein in conjunction with the composite element.

The connecting material may form a matrix in which the dissipative material is embedded.

The object is achieved by a dissipation arrangement according to the independent claim in this regard.

The discharge arrangement may, for example, be a sealing arrangement.

The discharge arrangement comprises:

a movable force transmission element extending along a longitudinal axis, e.g., a shaft of which the rotational axis forms the longitudinal axis, and/or a contact element,

a discharge element which is in electrical contact, e.g., in sliding contact, with an outer surface of the force transmission element or with an inner surface of the contact element,

and

a delimiting element which demarcates a first zone of the outer surface of the force transmission element from a second zone of the outer surface of the force transmission element or demarcates a first zone of the inner surface of the contact element from a second

zone of the inner surface of the contact element, wherein the first zone may be, for example, a lubrication zone and the second zone may be, for example, a discharge contact zone.

The delimiting element comprised by the discharge arrangement may be a sealing element.

Preferably, the discharge arrangement, e.g., the sealing arrangement, may comprise the movable force transmission element and the contact element. The discharge element may be arranged between the outer surface of the force transmission element and the inner surface of the contact element.

The discharge unit enclosed by the discharge arrangement, e.g., the sealing arrangement, may be a discharge unit according to the invention described herein, e.g., a sealing unit according to the invention described herein.

Preferably, the discharge arrangement, e.g., the sealing arrangement, may comprise a discharge unit according to the invention described herein, e.g., a sealing unit according to the invention described herein, wherein the discharge unit, e.g., the sealing unit, comprises the discharge element standing in the electrical contact, e.g., in the sliding contact, to the outer surface or to the inner surface , and wherein the discharge unit, e.g., the sealing unit, preferably comprises the delimiting element which separates the first zone from the second zone.

The discharge arrangement is preferably a discharge arrangement, wherein

a contact force measurable orthogonally to the outer surface of the force transmission element, with which the discharge element is held in electrical contact with the outer surface of the force transmission element, is at least 15 mN, preferably 15 mN to 20 N, particularly preferably 22 mN to 14 N,

or

a contact force measurable orthogonally to the inner surface of the contact element, with which a discharge element is held in electrical contact with the inner surface of the contact element, is at least 10 mN, preferably 10 mN to 20 N, particularly preferably 15 mN to 14 N.

The strengths specified for the aforementioned contact forces refer to the stationary state of the discharge arrangement, in which the force transmission element is not moved.

A contact force measurable orthogonally to the inner surface of the contact element may increase with rotation of the force transmission element, since the contact force can be amplified by centrifugal forces.

The contact force measurable orthogonally to the outer surface of the force transmission element, with which the discharge element is held in electrical contact with the outer surface of the force transmission element, can preferably be 15 mN to 20 N, particularly preferably 22 mN to 14 N.

The contact force measurable orthogonally to the inner surface of the contact element, with which a discharge element is held in electrical contact with the inner surface of the contact element, can preferably be 10 mN to 20 N, particularly preferably 15 mN to 14 N.

The contact force can be measured, for example, by increasing a counterforce acting against the contact force until the discharge element lifts off from the outer surface or from the inner surface. The counterforce that must be built up until the discharge element lifts off from the outer surface or from the inner surface is preferably regarded as the contact force.

Preferably, the discharge element, in particular at least one discharge contact area of the discharge element, which is in electrical contact, e.g., in the sliding contact, with the outer surface or the inner surface, can be deformed, elastically deformed, and/or prestressed by a movement parallel to a plane, e.g., a prestress plane.

Preferably, the longitudinal axis of the force transmission element can lie in the plane, e.g., in the prestress plane, or intersect the plane, e.g., the prestress plane, at an angle of at most 15°, in particular at most 5°.

Preferably, the longitudinal axis of the force transmission element can intersect the plane, e.g., the prestress plane, at an angle of 75° to 90°, in particular 85° to 90°.

The object is achieved by a force transmission arrangement according to the invention in accordance with the relevant independent claim.

The force transmission arrangement may in particular be a force transmission arrangement for an electric machine.

The force transmission arrangement comprises the following:

a movable force transmission element extending along a longitudinal axis, wherein the force transmission element is preferably a shaft of which the rotational axis forms the longitudinal axis,

a bearing in which the movable force transmission element is mounted so as to be movable, in particular rotatable and/or translatable, e.g., rotatable,

a discharge element which is in electrical contact, e.g., in sliding contact, with a surface, with an outer surface of the force transmission element or with an inner surface of a contact element, and

a delimiting element which demarcates a first zone in which the bearing is arranged from a second zone in which the discharge element is in electrical contact, e.g., in sliding contact, with the surface.

Preferably, the discharge element comprised by the force transmission arrangement may be arranged between the outer surface of the force transmission element and the inner surface of the contact element.

The force transmission arrangement may comprise the contact element.

The contact element may be a component, e.g., a machine element.

The bearing may preferably be a rolling bearing.

The movable force transmission element may be rotatably mounted in the rolling bearing, wherein the movable force transmission element is preferably the shaft.

If the discharge element is in electrical contact with an inner surface of the contact element, the discharge element may preferably extend from an inner carrier element to the inner surface of the contact element.

The inner carrier element may be fastened to the outer surface of the force transmission element.

If the discharge element is in electrical contact with the outer surface of the force transmission element, the discharge element may preferably extend from an outer carrier element to the outer surface of the force transmission element.

The outer carrier element may preferably be fastened to an inner surface of the contact element.

Preferably, the force transmission arrangement may comprise a discharge unit according to the invention described herein, e.g., a sealing unit according to the invention described herein, and/or a discharge arrangement according to the invention described herein, e.g., a sealing arrangement according to the invention described herein.

The discharge unit comprised by the force transmission arrangement, e.g., the sealing unit comprised by the force transmission arrangement, may preferably comprise the discharge element in electrical contact, e.g., in sliding contact, with the outer surface or the inner surface.

The dissipation unit enclosed by the force transmission arrangement, e.g., the sealing unit enclosed by the force transmission arrangement, may preferably comprise the delimiting element that demarcates the first zone from the second zone.

Features described in conjunction with a subject according to the invention may, of course, also represent features of another object described herein. Subjects according to the invention are, in particular, the discharge unit, the sealing unit, the discharge arrangement, the sealing arrangement, and the force transmission arrangement.

Further preferred features and/or advantages of the invention are the subject of the following description and the drawings of embodiments.

### BRIEF DESCRIPTION OF THE DRAWINGS

FIG. 1: a schematic sectional view of a force transmission arrangement;

FIG. 2: an enlarged detail of FIG. 1;

FIG. 3: an enlarged detail of FIG. 1;

FIG. 4: a first discharge element;

FIG. 5: a second discharge element;

FIG. 6: the first and second discharge elements from FIGS. 4 and 5;

FIG. 7: a schematic sectional view of a force transmission arrangement;

FIG. 8: a schematic sectional view of a force transmission arrangement;

FIG. 9: a schematic sectional view of a force transmission arrangement;

FIG. 10: a sealing unit, wherein part of the sealing unit has been removed for illustrative purposes;

FIG. 11: a discharge unit, wherein part of the discharge unit has been removed for illustrative purposes;

FIG. 12: a perspective view of a section through a discharge unit;

FIG. 13: a schematic sectional view of a force transmission arrangement;

FIG. 14: a perspective view of a section through a discharge unit;

FIG. 15: a schematic sectional view of a force transmission arrangement;

FIG. 16: a schematic sectional view of a force transmission arrangement;

FIG. 17: a schematic sectional view of a force transmission arrangement;

FIG. 18: a schematic sectional view of a force transmission arrangement;

FIG. 19: three different representations of a discharge element;

FIG. 20: a further representation of the discharge element shown in FIG. 19;

FIG. 21: a schematic sectional view of a force transmission arrangement and a representation of the associated discharge element and delimiting element;

FIG. 22: a schematic sectional view of a force transmission arrangement and a representation of the associated discharge element and delimiting element;

FIG. 23: a schematic sectional view of a force transmission arrangement; and

FIG. 24: two views showing the prestressing of a discharge element by means of a prestress plane.

Identical or functionally equivalent elements are designated by the same reference numerals in all figures.

### DETAILED DESCRIPTION OF THE DRAWINGS

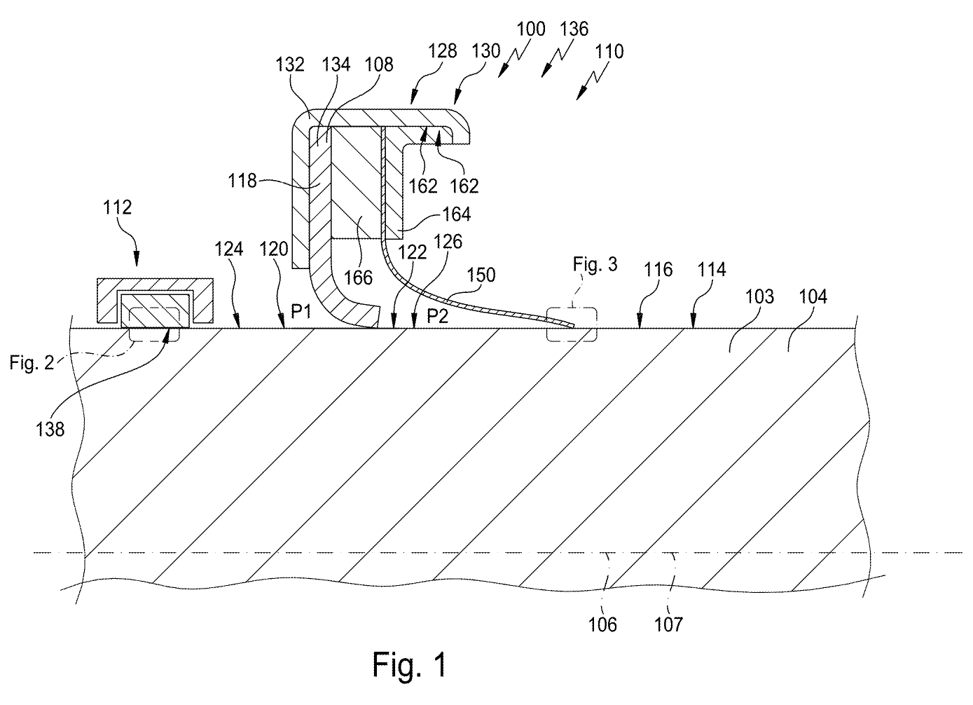

FIG. 1 shows a force transmission arrangement 110. The force transmission arrangement 110 is suitable for an electric machine. The force transmission arrangement 110 comprises a movable force transmission element 103. The movable force transmission element 103 extends along a longitudinal axis 106. The force transmission element 103 is a shaft 104 of which the rotational axis 107 forms the longitudinal axis 106.

The force transmission arrangement 110 comprises a bearing 112. The movable force transmission element 103 is movable in the bearing 112. The movable force transmission element 103 is rotatably mounted in the bearing 112.

The force transmission arrangement 110 comprises a discharge element 150. The discharge element 150 is in electrical contact with a surface 114 of the force transmission element 103. The electrical contact is a sliding contact. The surface 114 of the force transmission element 103 is an outer surface 116 of the force transmission element 103.

The force transmission assembly 110 comprises a delimiting element 118. The delimiting element 118 separates a first zone 120, in which the bearing 112 is located, from a second zone 122, in which the discharge element 150 is in electrical contact with the surface 114.

The first zone 120 is a lubrication zone 124. The second zone 122 is a dissipation contact zone 126.

The force transmission arrangement 110 shown in FIG. 1 comprises a discharge unit 128. The discharge unit 128 is a sealing unit 130.

The discharge unit 128 comprises the discharge element 150, which is in electrical contact with the outer surface 116. The discharge unit 128 comprises the delimiting element 118, which separates the first zone 120 from the second zone 122.

The discharge unit 128 comprises an outer carrier element 132. The outer carrier element 132 is positioned so that it does not contact the outer surface 116.

The discharge element 150 is fastened to the outer carrier element 132. The discharge element 150 extends in the direction towards the longitudinal axis 106 and radially inwardly.

The discharge unit comprises a delimiting element 118, which is fastened to the outer carrier element 132 and extends in the direction towards the longitudinal axis and radially inwardly, as already mentioned in conjunction with FIG. 1. The delimiting element 118 is a barrier element 134 which forms a barrier between the first zone 120 and the second zone 122.

The delimiting element 118 is a sealing element 108. The sealing element 108 is annular. The discharge unit 128 thus forms a sealing unit 130.

The force transmission element 103, the discharge element 150, and the delimiting element 118 together form a discharge arrangement 136. The discharge arrangement 136 is a sealing arrangement 100.

FIG. 1 also shows a bearing zone 138. In the bearing zone 138, the movable force transmission element 103 is rotatably mounted in the bearing 112.

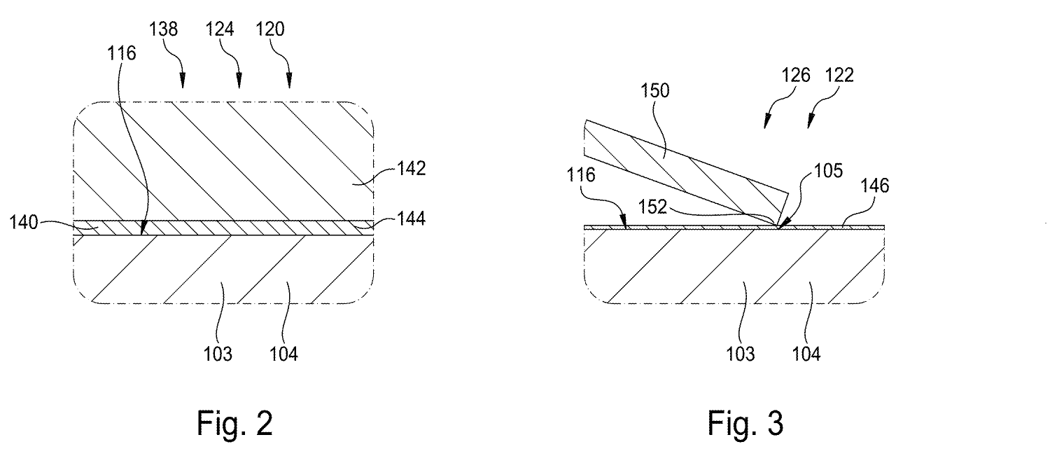

FIG. 2 shows an enlarged view of the bearing zone 138 from FIG. 1. The bearing zone 138 forms part of the first zone 120. As already described in conjunction with FIG. 1, the first zone 120 is the lubrication zone 124.

A lubricant 140 extends from the bearing zone 138 into the lubrication zone 124. Between the outer surface 116 and bearing elements 142, the lubricant 140 forms a first lubricant layer 144.

FIG. 3 shows an enlarged view of the surface contact area 105 from FIG. 1. There, a portion of the lubricant 140 that passes the sealing element 108 along the outer surface 116 into the second zone 122 forms a second lubricant layer 146. Preferably, the second lubricant layer 146 can be significantly thinner than the first lubricant layer 144.

In particular, this can promote discharge in the transition from the discharge element 150 to the outer surface 116 as opposed to discharge in the area of the bearing zone 138, so that discharges do not occur or occur less frequently in the bearing and bearing damage caused by electroerosion does not occur or occurs significantly later.

FIG. 3 also shows that the discharge element 150 comprises a discharge contact area 152 extending in the direction towards the longitudinal axis 106 and radially inwardly. Due to the arrangement of the discharge unit 150 on the force transmission element 103, the discharge contact area 152 is brought into electrical contact with the outer surface 116.

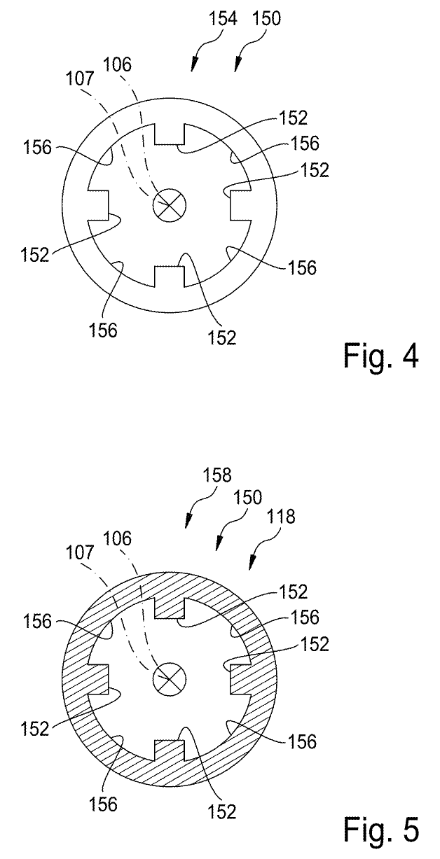

FIG. 4 shows a discharge element 150. The discharge element 150 is a first discharge element 154. The discharge element 150 shown in FIG. 4 comprises several discharge contact areas 152 spaced apart from one another.

The discharge element 150 shown in FIG. 4 is annular. It can be arranged around the force transmission element 103, e.g., around the shaft 104. The longitudinal axis 106, e.g., the rotational axis 107, of the force transmission element 103, e.g., the shaft 104, then extends in the direction towards the viewer, as indicated in FIG. 4.

The discharge element 150 extends radially further inward in the direction towards the longitudinal axis 106 in the discharge contact areas 152 than in the intermediate areas 156 located between the discharge contact areas 152.

FIG. 5 shows a further discharge element 150. The further discharge element 150 is a second discharge element 158. The shape of the second discharge element 158 shown in FIG. 5 corresponds to the shape of the first discharge element 154 shown in FIG. 4.

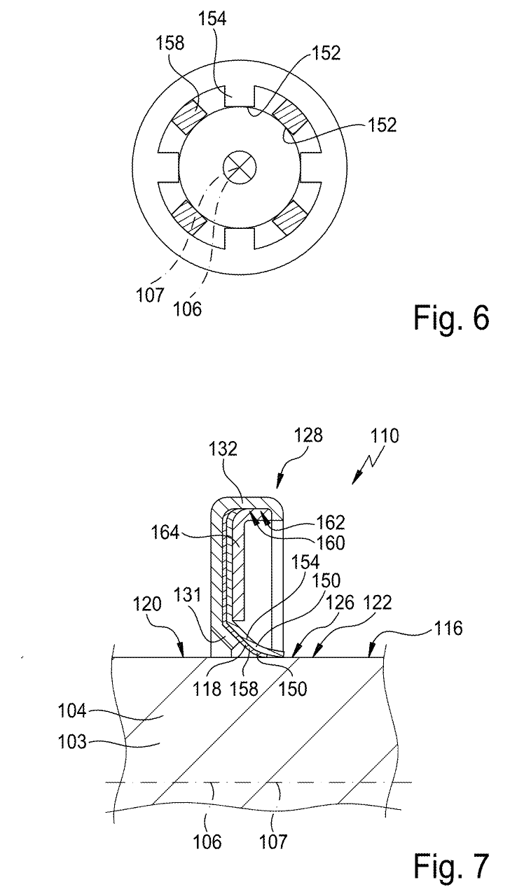

In a discharge unit according to the invention, the discharge element can be a first discharge element and the delimiting element or a further discharge element comprised in the discharge unit can be a second discharge element. FIG. 6 shows two discharge elements that can be used in this sense. The discharge elements shown in FIG. 6 are arranged such that the intermediate areas of one discharge element overlap with the discharge contact areas 152 of the other discharge element. In the example shown in FIG. 6, the discharge contact areas 152 are each arranged exactly in the center of the intermediate areas of the other discharge element.

FIG. 7 shows a discharge unit 128.

The discharge unit 128 comprises an outer carrier element 132 and a discharge element 150 fastened to the outer carrier element and extending in the direction towards the longitudinal axis 106 and radially inwardly.

The discharge element 150 is a first discharge element 154. The discharge unit 128 comprises a further discharge element 150. The further discharge element 150 is a second discharge element 158. The first and second discharge elements 154 and 158 extend in the same direction. The first discharge element 154 and the second discharge element 158 are each a discharge element 150 extending in the direction towards the longitudinal axis and radially inwardly.

The discharge elements 154 and 158 shown in FIG. 7 may, for example, be the discharge elements 154 and 158 shown in FIG. 6.

In the discharge unit 128 shown in FIG. 7, the delimiting element 118 is the second discharge element 158.

The delimiting element 118 is a delimiting element 118 fastened to the outer carrier element and extending in the direction towards the longitudinal axis and radially inwardly. FIG. 7 clearly shows that, when the discharge unit 128 is arranged on the force transmission element 103, the delimiting element 118 delimits a first zone 120 of the outer surface 116 of the force transmission element 103 from a second zone 122 of the outer surface of the force transmission element.

As already explained in conjunction with FIG. 1, the second zone 122 may be a discharge contact zone 126.

If the delimiting element 118 shown in FIG. 7 is the second discharge element 158 shown in FIGS. 5 and 6, the discharge contact areas 152 of the delimiting element 118 come into electrical contact with the outer surface 116 when the discharge unit 128 is arranged on the force transmission element 103. Since the intermediate areas 156 of the delimiting element 118 typically do not extend to the outer surface 116 when the discharge unit 128 is arranged on the force transmission element 103, the second zone 122 is not sealed off from the first zone 120 by the delimiting element 118 shown in FIG. 7.

When the discharge unit 128 shown in FIG. 7 is used in a force transmission arrangement 110, it is therefore advantageous to provide a further delimiting element 118 between the first zone 120 and a bearing 112, which is designed as a sealing element 108.

In this case, the first zone shown in FIG. 7 would not be the lubrication zone 124. The lubrication zone 124 would then extend from the bearing 112 to the sealing element 108.

In the discharge unit 128 shown in FIG. 7, the two discharge elements 154 and 158 are reshaped, elastically deformed, and/or prestressed by means of an inclined alignment portion 131 of the discharge unit 128.

The discharge unit 128 shown in FIG. 7 comprises a receiving zone 160. The receiving zone 160 extends radially outwardly into a receiving recess 162 formed on the outer carrier element 132.

The two discharge elements 154 and 158 are fastened to the outer carrier element by means of a fixing element 164. The fixing element 164 is partially received in the receiving recess 162.

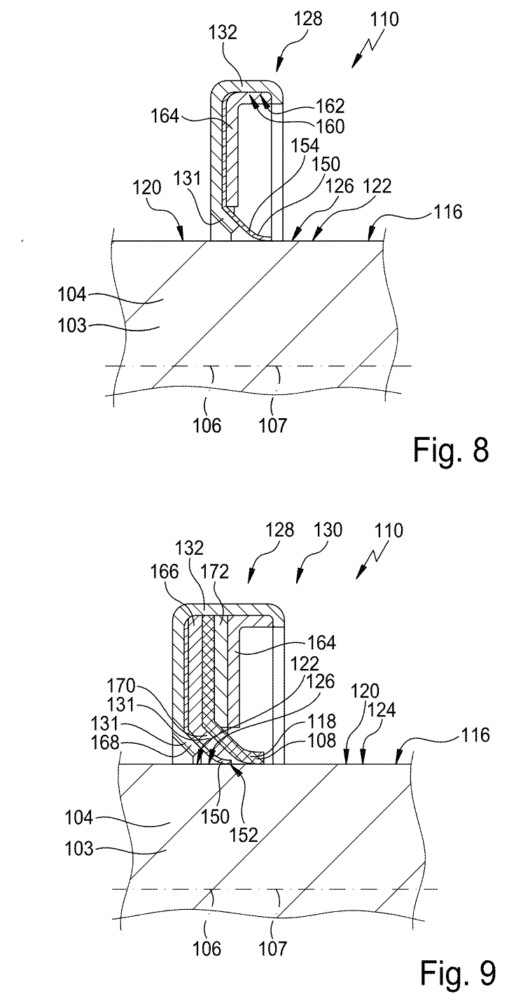

The discharge unit 128 shown in FIG. 8 corresponds to the discharge unit 128 shown in FIG. 7. It differs from the discharge unit 128 shown in FIG. 7 in that it comprises only one discharge element 150.

FIG. 9 shows a discharge unit 128. The discharge unit 128 is a sealing unit 130. The discharge unit shown in FIG. 9 has features that have already been described in conjunction with FIGS. 1 to 8, in particular in conjunction with FIGS. 1 and 7. In the discharge unit 128 shown in FIG. 9, the discharge element 150 is reshaped, elastically deformed, and/or prestressed by means of an alignment portion 131 of the discharge unit 128 that runs at an angle .

A first alignment portion 168 is an alignment portion 131 formed on the outer carrier element 132.

The discharge unit shown in FIG. 9 comprises a separation element 166. A second alignment portion 170 is an alignment portion 131 formed on the separation element 166. The separation element 166 is arranged between the discharge element 150 and the delimiting element 118, which is a sealing element 108. The separation element 166 thus separates the discharge element 150 from the delimiting element 118.

The discharge element is reshaped, elastically deformed, and/or prestressed between the first inclined alignment portion 168 and the second inclined alignment portion 170.

The two alignment portions 168 and 170 run essentially parallel to each other.

The discharge unit 128 shown in FIG. 9 comprises a retaining element 172, which also has a static sealing effect. The retaining element 172 is arranged between the fixing element 164 and the delimiting element 118. The retaining element 172 can act as a secondary static sealing element.

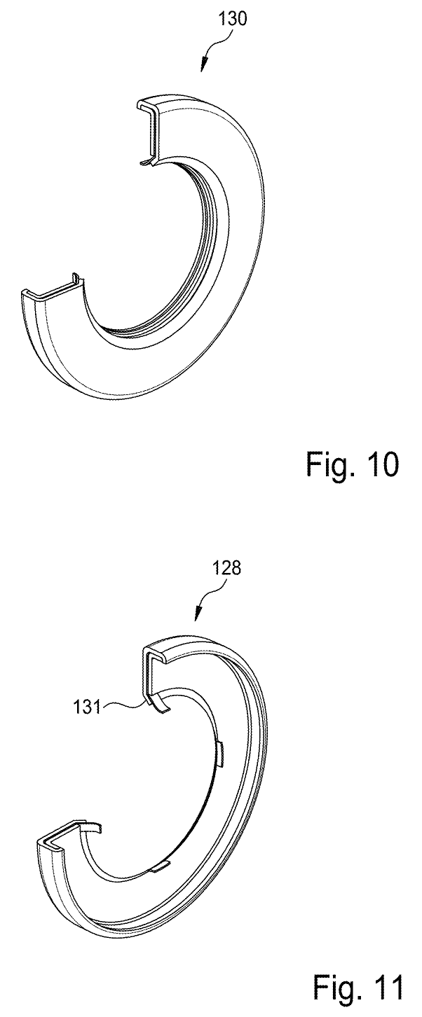

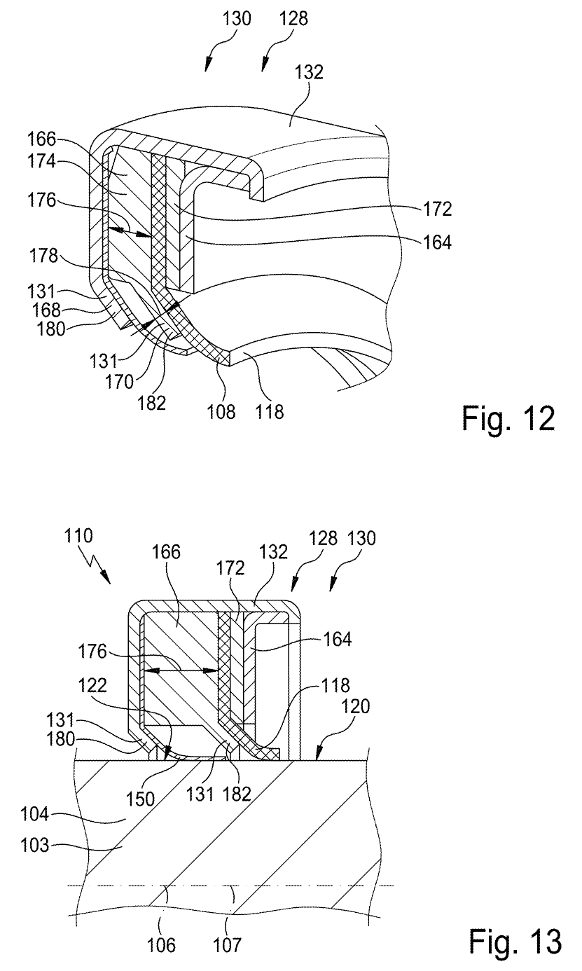

The invention makes it possible to integrate the sealing function of a sealing unit 130 shown in FIG. 10 and the discharge function of a discharge unit 128 shown in FIG. 11 into a discharge unit 128, which is also a sealing unit 130. An example of a discharge unit 128 that is also a sealing unit 130 is shown in FIG. 12.

The structure of the discharge unit 128 shown in FIG. 12 largely corresponds to the structure of the discharge unit 128 shown in FIG. 9.

FIG. 12 shows that the separation element 166 has a separation portion 174. A separation portion thickness 176 of the separation element 166 at the separation sec 174 is greater than an alignment portion thickness 178 of the separation element 166 at an alignment portion 131 of the separation element 166. The separation portion thickness 176 can be measured in the axial direction. The alignment portion thickness 178 may be a thickness measured orthogonally to a surface of the alignment portion.

The first alignment portion 168 is a discharge element alignment portion 180. The second alignment portion 170 is a sealing element alignment portion 182.

The sealing element alignment portion abuts a surface of the sealing element 108, whereby the sealing element 108 is reshaped, elastically deformed, and/or prestressed. The discharge element alignment portion 180 rests against a surface of the discharge element 150, whereby the discharge element 150 is reshaped, elastically deformed and/or prestressed.

A part of the sealing element alignment portion 182 extends spaced apart from the discharge element 150 in the direction towards an outer surface 116 of a force transmission element 103 on which the discharge unit 128 can be arranged.

FIG. 13 illustrates one way of increasing the separation portion thickness 176 of the separation element 166. Apart from the greater separation portion thickness 176, the discharge unit shown in FIG. 13 largely corresponds to the discharge unit 128 shown in FIG. 12.

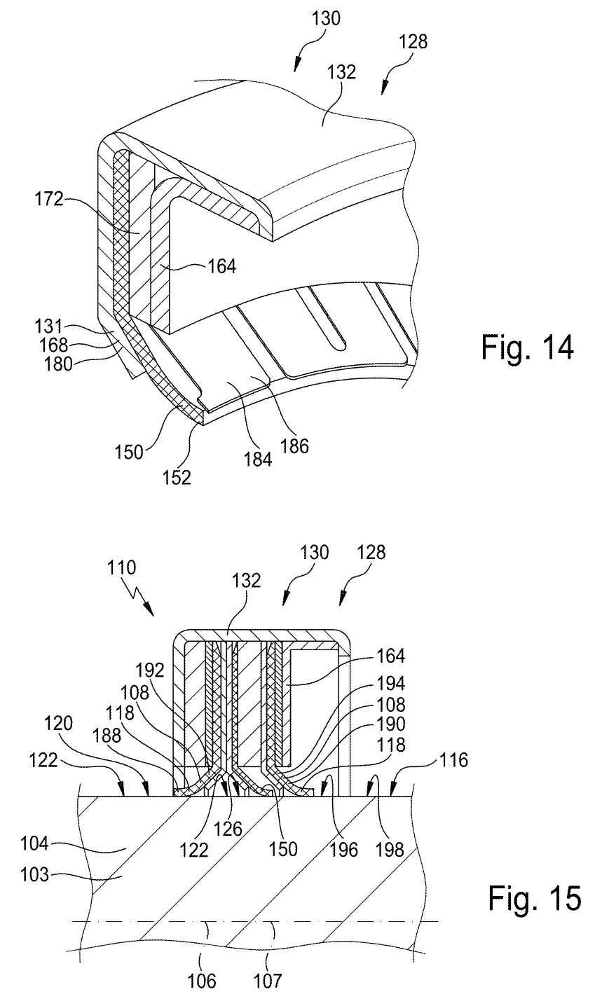

FIG. 14 shows a discharge unit 128 comprising a pressing element 184. The pressing element 184 is a spring plate 186. The pressing element 184 presses the discharge element

150 of the discharge unit, e.g., a discharge contact area 152 of the discharge element 150, can be pressed against an outer surface 116 of the force transmission element 103, which is not shown in FIG. 14, when the discharge unit 128 is arranged on a force transmission element 103. This allows electrical contact between the discharge element and the outer surface of the force transmission element 103 to be reinforced.

The discharge unit 128 shown in FIG. 15 is a sealing unit 130. It comprises two delimiting elements 118. The delimiting element 118 shown on the left in the figure is a first delimiting element 188. The delimiting element 118 shown on the right in FIG. 15 is a second delimiting element 190. Both delimiting elements 118, 188, 190 are sealing elements 108. The first delimiting element 188 shown on the left in FIG. 15 is a first sealing element 192. The second delimiting element 190 shown on the right in FIG. 15 is a second sealing element 194. FIG. 15 shows that, when the discharge unit 128 is arranged on the force transmission element 103, the first delimiting element 188 separates a first zone 120 of the outer surface 116 of the force transmission element 103 from a second zone 122 of the outer surface 116 of the force transmission element 103.

FIG. 15 also shows that, when the discharge unit 128 is arranged on the force transmission element 103, the second delimiting element 190 delimits the second zone 122 of the outer surface 116 of the force transmission element 103 from a third zone 196 of the outer surface 116 of the force transmission element 103.

As already explained in conjunction with other figures, the first zone 120 can be a lubrication zone 124. The second zone 122 can be a discharge contact zone 126. The third zone 196 can be a further lubrication zone 198.

An advantage explained in particular in conjunction with FIGS. 2 and 3 can also arise with the discharge unit 128 shown in FIG. 15, for example, if the bearing on the force transmission element 103 is arranged to the left or right of the discharge unit shown in FIG. 15, since the two sealing elements 108, 192, 194 are arranged on both sides of the discharge element, the two sealing elements 108, 192, 194 can counteract the penetration of lubricant into the discharge contact zone 126 in both directions.

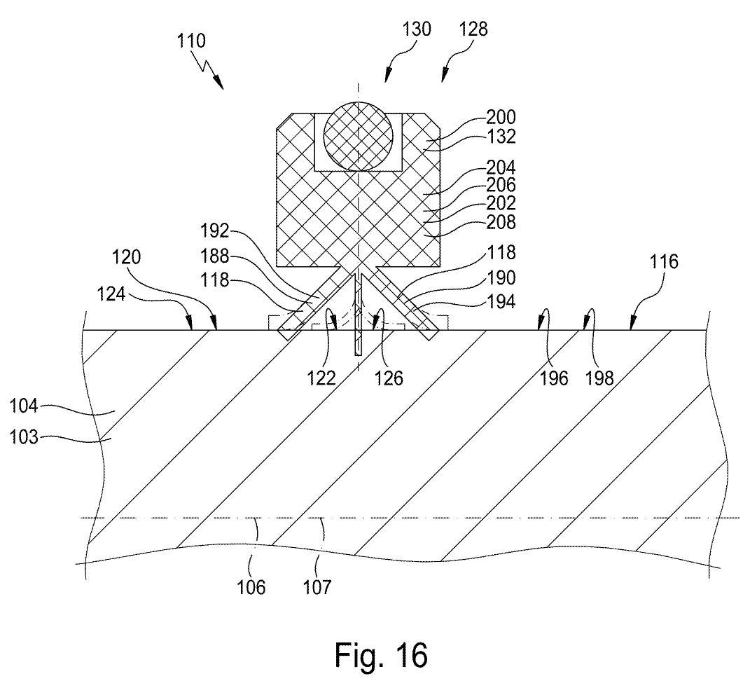

FIG. 16 shows a discharge unit 128. The discharge unit 128 is a sealing unit 130. In the discharge unit 128 shown in FIG. 16, the discharge element 150 and the delimiting element 118 extend from an outlet zone 200 of the discharge unit 128.

The discharge element 150, the delimiting element 118, and the outlet zone 200 are formed by an electrically conductive body 204 containing a discharge material 202. The body 204 can function as the outer carrier element 132.

The delimiting element 118 shown on the left in FIG. 16 may, for example, be a first delimiting element 188. The delimiting element 118 shown on the right in FIG. 16 may, for example, be a second delimiting element 190. In the discharge unit shown in FIG. 16, the second delimiting element 190 is also formed by the body 204. The body 204 is a composite body 206. The composite body 206 comprises a dissipative material 202 and a connecting material 208. The dissipative material 202 is embedded in the connecting material 208.

In the arrangement of the dissipation unit 128 shown in FIG. 16, the division of the outer surface 116 into a first zone 120, a second zone 122, and a third zone 196, as already described in conjunction with FIG. 15, can result in the advantages also described in conjunction with FIG. 15.

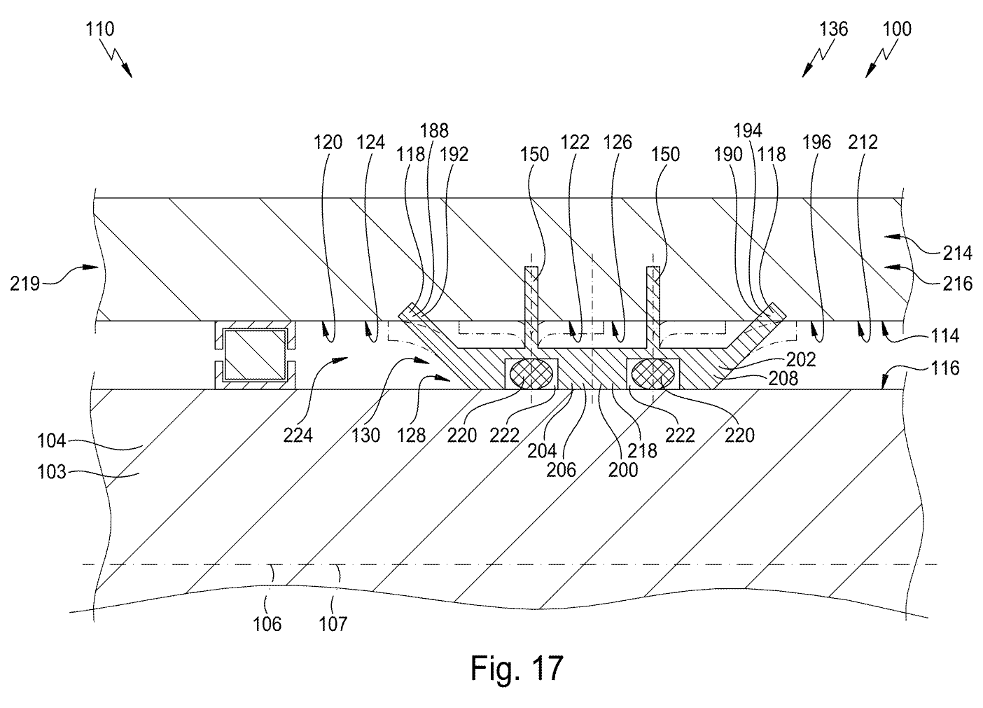

FIG. 17 shows a force transmission arrangement 110.

The force transmission arrangement 110 comprises a movable force transmission element 103. The movable force transmission element 103 extends along a longitudinal axis 106. The force transmission element 103 is a shaft 104 of which the rotational axis 107 forms the longitudinal axis 106.

The force transmission arrangement 110 comprises a bearing 112. The movable force transmission element 103 is rotatably mounted in the bearing 112.

The force transmission arrangement 110 comprises a discharge element 150. The discharge element 150 is in electrical contact with a surface 114. The electrical contact may be a sliding contact. The surface with which the discharge element is in electrical contact is an inner surface 212 of a contact element 214. The inner surface 212 is a radially inwardly oriented inner surface 212. The radially inwardly oriented inner surface is cylindrical. The

inner surface 212 may be an inner surface of a cylindrical recess extending through the contact element 214. The contact element 214 may be a component 216, for example a steel component, which has the recess.

The force transmission arrangement 110 comprises a delimiting element 118 which separates a first zone 120, in which the bearing 112 is arranged, from a second zone 122, in which the discharge element 150 is in electrical contact with the surface 114.

The first zone 120 is a lubrication zone 124. The second zone 122 is a dissipation contact zone 126.

The delimiting element 118 shown on the left in FIG. 17 is a first delimiting element 188.

The force transmission arrangement 110 comprises a second delimiting element 190, which is shown on the right in FIG. 17. The first delimiting element 188 is a first sealing element 192. The second delimiting element 190 is a second sealing element 194.

The second delimiting element 190 separates a third zone 196 from the second zone 122.

The force transmission assembly 110 comprises a further discharge element 150, which, like the discharge element 150 mentioned previously in conjunction with FIG. 17, is in electrical contact with the surface 114 of the contact element.

The force transmission arrangement 110 shown in FIG. 17 comprises a discharge unit 128. The discharge unit 128 is a sealing unit 130.

The discharge unit 128 comprises the two discharge elements 150 in electrical contact with the surface 114, as well as the first delimiting element 188 and the second delimiting element 190, which delimit the three zones 120, 122, 196 from each other.

In contrast to the other discharge units 128 shown in the figures, the discharge unit shown in FIG. 17 comprises an inner carrier element 218. The inner carrier element 218 is fastened to the outer surface 116 of the force transmission element 103. It is fastened to the outer surface 116 by means of two O-rings 220, which are received in two recesses 222 of the discharge unit 128. The two deflection elements 150 described in conjunction with

FIG. 17 are fastened to the inner carrier element 218 and each extend away from the longitudinal axis 106 and radially outwardly.

The two delimiting elements 118, 188, 190 described in conjunction with FIG. 17 are fastened to the inner carrier element 218 and also extend away from the longitudinal axis 106 and radially outwardly.

The delimiting elements and discharge elements described in conjunction with FIG. 17 extend from an outlet zone 200 of the discharge unit 128. The discharge elements and delimiting elements are formed by an electrically conductive body 204. The electrically conductive body 204 contains a discharge material 202. The body 204 is a composite body 206. The composite body 206 comprises the discharge material 202 and a connecting material 208. The discharge material 202 is embedded in the connecting material 208.

FIG. 17 shows that the bearing 112 and the dissipation unit 128 are arranged in a hollow cylindrical gap 224, which is bounded inwardly by the outer surface 116 of the force transmission element 103 and outwardly by the inner surface 212 of the component 216. The component 216 may be a machine element 219.

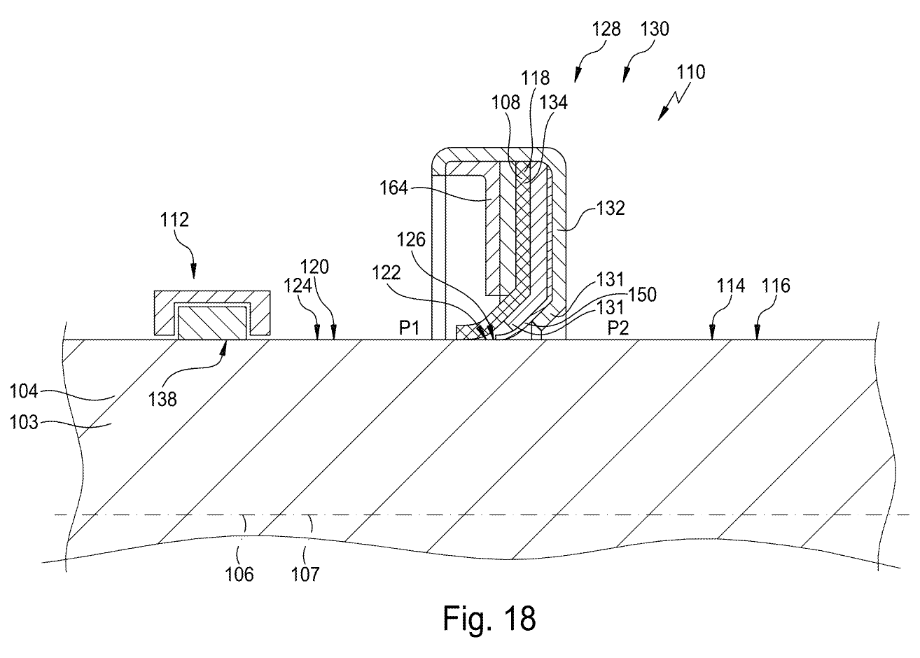

FIG. 18 shows another force transmission arrangement 110. The force transmission arrangement 110 comprises the discharge unit 128 shown in FIG. 9.

In FIG. 1, the sealing element 108 extends from the outer carrier element 132 in the axial direction away from the bearing 112. In FIG. 18, the sealing element 108 extends from the outer carrier element 132 in the axial direction in the direction towards the bearing 112.

The force transmission arrangement shown in FIG. 1 is designed for applications in which a pressure P1 is established in the first zone 120 that is lower than a pressure P2 established in the second zone 122.

The force transmission arrangement shown in FIG. 18 is designed for applications in which a pressure P1 is established in the first zone 120 that is greater than a pressure P2 established in the second zone 122.

The arrangements shown in FIGS. 1 and 18 are also advantageous in the case of pressureless lubricant and, in particular, oil seals, since an increased capillary effect of, for example, low-viscosity oil in the sealing gap can be minimized. Both arrangements can therefore also be used to particular advantage when the pressure P1 does not differ from the pressure P2, or only differs slightly.

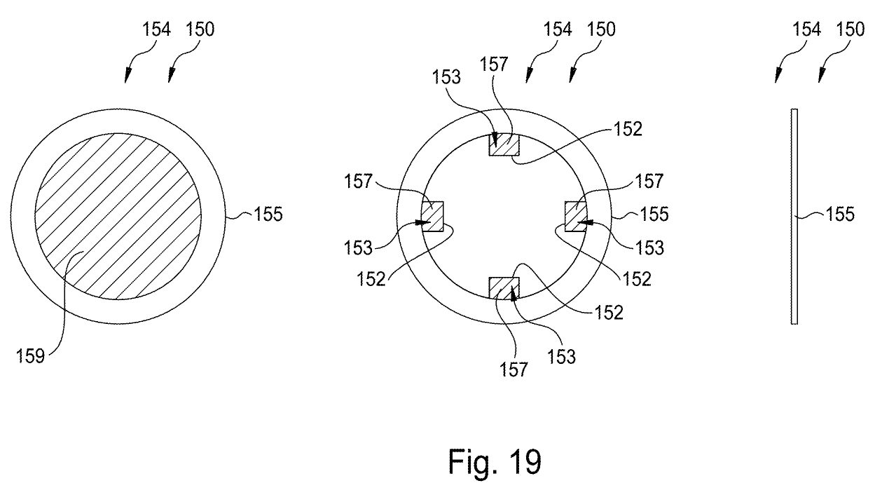

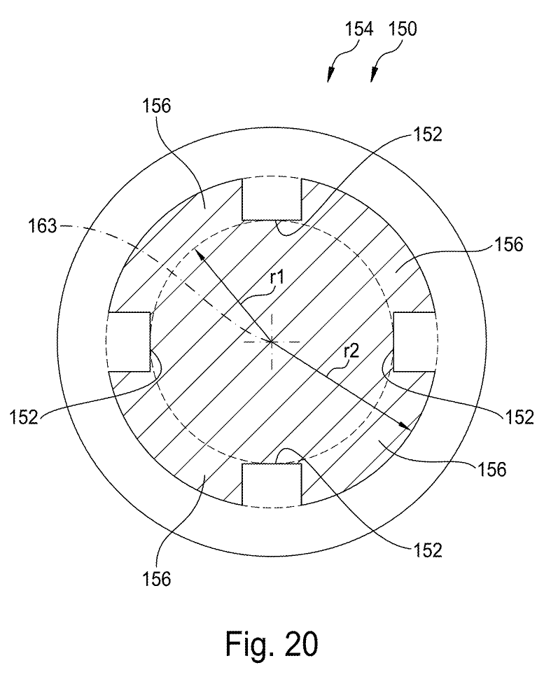

FIG. 19 shows three different representations of a discharge element 150. The discharge element 150 is the first discharge element 154 shown in FIG. 4. The deflection element 150, 154 is shown in a flat basic state, in which it is present when it is not arranged on a force transmission element 103 and is also not formed, elastically deformed, and/or prestressed by means of an inclined alignment portion 131. This is particularly clear from the view shown on the far right in FIG. 19, in which an outer edge 155 of the discharge element 150, 154 faces the viewer. In the basic state shown, the discharge contact areas 152 also do not protrude from a plane along which the entire discharge element 150, 154 extends.

The discharge element 150, 154 comprises four dischargers 153, each of which extends in the direction towards one of the four discharge contact areas 152. Each discharge element occupies a discharge area 157. The discharge area 157 of each discharge element 153 is at least 1% to at most 10% of a recess area 159 surrounded by the discharge element 150, 154 into which the discharge elements 153 protrude.

FIG. 20 also shows the discharge element 150, 154 depicted in FIG. 19. The discharge element 150, 154 can be described by two circles of which the centers 163 coincide. An inner circle has a radius r1. An outer circle has a radius r2. The radius r1 corresponds to the distance from a discharge contact area 152 to the center point 163. The radius r2 is selected so that the area of the outer circle corresponds to the recess area 159. The ratio of r1 to r2 is approximately 0.65.

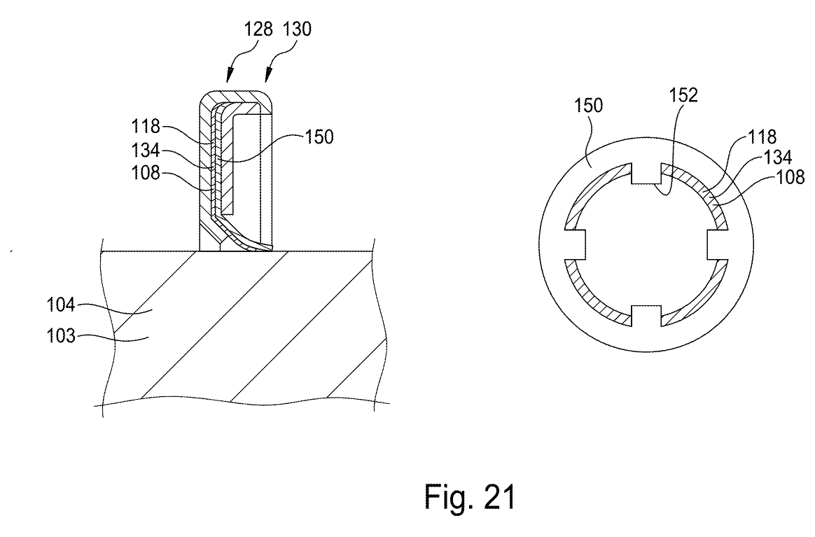

FIG. 21 shows a discharge unit 128. The discharge unit 128 is similar to the discharge unit shown in FIG. 7. The discharge unit 128 shown in FIG. 21 is a sealing unit 130. The delimiting element 118 is a sealing element 108. This is particularly clear from the illustration shown on the right in FIG. 21, which shows not only the discharge element 150 but also the delimiting element 118 designed as a sealing element 108.

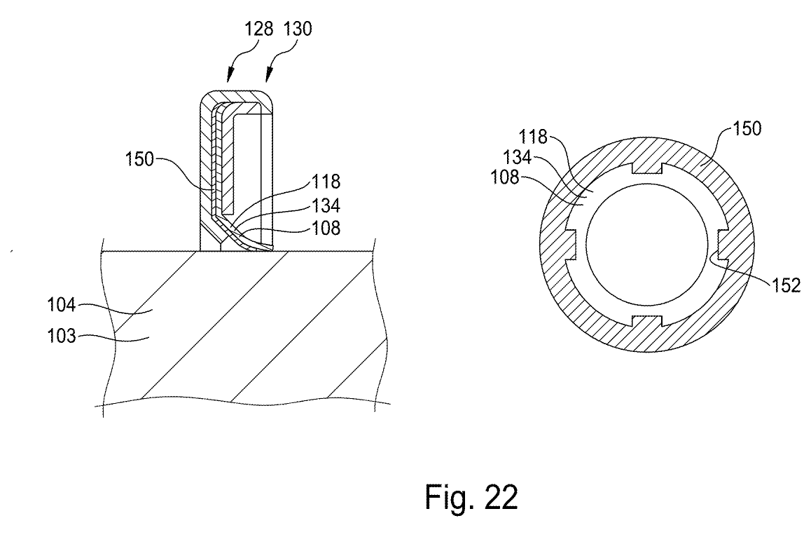

FIG. 22 also shows a discharge unit 128. This differs from the discharge unit in FIG. 21 in the arrangement of the discharge element 150 and the sealing element 108. In addition, the discharge contact areas 152 of the discharge element 150 are shorter than the discharge contact areas 152 of the discharge element 150 shown in FIG. 21.

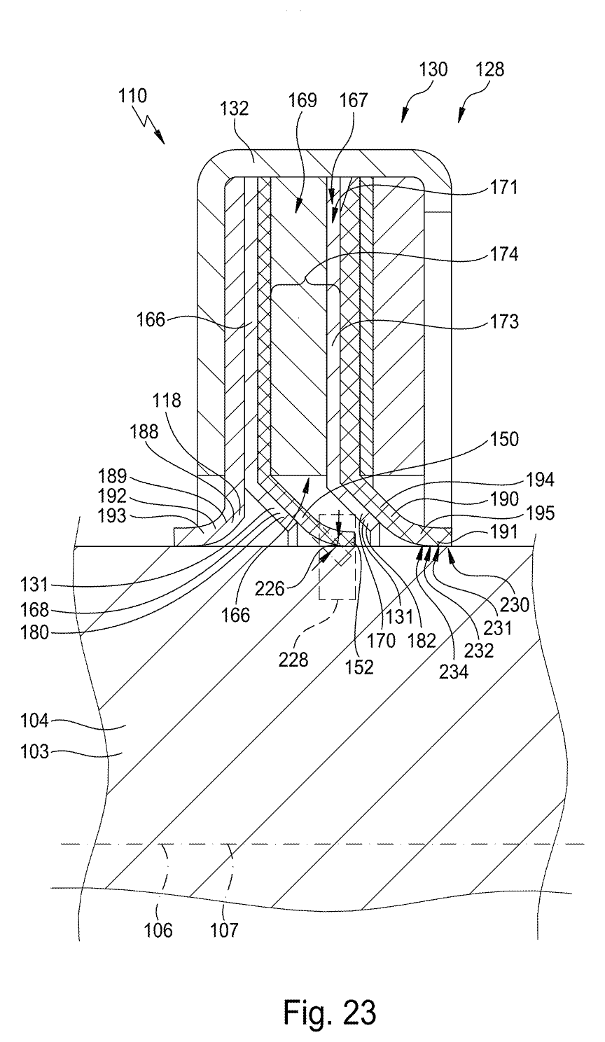

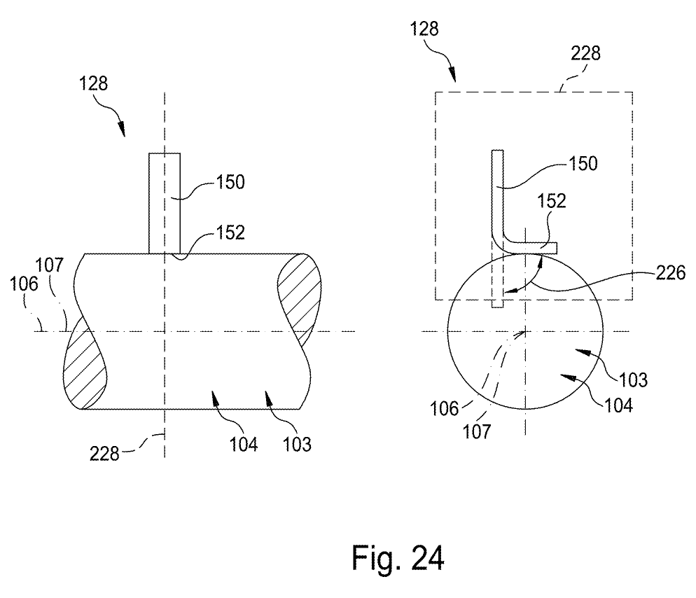

The discharge unit 128 shown in FIG. 23 is a sealing unit 130. It comprises several separation elements 166. One of the separation elements 166 is multi-part. It has a first separation component 167 and a second separation component 169.

The first separation component 167 has an alignment portion 131. The alignment portion 131 is a sealing element alignment portion 182. The first separation component 167 is a deep-drawn separation component 171 obtained by deep drawing.

A material thickness of the deep-drawn separation component 171 in the region of the sealing element alignment portion 182 corresponds to a material thickness in the region of a radial extent portion 173 of the deep-drawn separation component 171 adjoining the alignment portion, e.g., the sealing element alignment portion.

A material thickness of the second separation component 169 measurable in the direction of the longitudinal axis 106 is greater than a material thickness of the first separation component 167 measurable in the direction of the longitudinal axis. The two separation components 167 and 169 are annular. The inner diameter of the second separation component 169 is greater than the inner diameter of the sealing element alignment portion 182.

The separation element 166 has a separation portion 174 formed radially outside the sealing element alignment portion 182, which is formed by the second separation component 169 and the radial extent portion 173 of the first separation component 167.

The discharge unit 128 shown in FIG. 23 comprises an outer carrier element 132 and a deflection element 150 fastened to the outer carrier element 132 and extending in the direction towards the longitudinal axis 106 and radially inwardly. The discharge unit 128 also comprises two delimiting elements 118, 188, 190 fastened to the outer carrier element 132 and extending radially inwardly in the direction towards the longitudinal axis 106.

The first delimiting element 188 is a first sealing element 192. The first delimiting element 188 is a rotated delimiting element 189. It is therefore a first rotated sealing element 193.

The second delimiting element 190 is a second sealing element 194. The second delimiting element 190 is a shaped delimiting element 191. It is therefore a first shaped sealing element 195.

By arranging the discharge unit 128 on the force transmission element 103, a first zone of the outer surface of the force transmission element, which may be a lubrication zone, for example, can be separated from a second zone of the outer surface of the force transmission element, which may be a discharge contact zone, for example.

The described multi-part separation element 166 is arranged between the discharge element 150 and the shaped sealing element 195, wherein the shaped sealing element 195 is reshaped, elastically deformed, and/or prestressed by means of the inclined sealing element alignment portion 182.

A further separation element 166 is arranged between the discharge element 150 and the rotated sealing element 193, wherein the discharge element 150 is reshaped, elastically deformed and/or prestressed by means of the inclined alignment portion 131 of this further separation element 166.

The shaped sealing element 193 has a sealing surface 230. The sealing surface 230 has a lubricant retention structure 231 in which a first spiral groove 232 and a second spiral groove 234 are formed. The spiral grooves 232 and 234 can be designed, for example, as described elsewhere herein independently of FIG. 23.

FIG. 23 shows a small section of a plane that can be used to define the discharge unit 228 in more detail. The plane is a prestress plane 228. The longitudinal axis lies in the prestress plane 228. The discharge element 150, in particular a discharge contact area 152 of the discharge element 150, is reshaped, elastically deformed, and/or prestressed by a movement 226 parallel to the prestress plane 228.

FIG. 24 shows a discharge unit 128 from two different viewing directions and in a greatly simplified form, wherein the carrier element in particular is omitted. The discharge element

150 comprises a discharge contact area 152. However, it is oriented quite differently from the discharge elements 128 shown in the other figures. Although the discharge contact area 152 of the discharge element 150 is also deformed, elastically deformed and/or prestressed in the discharge unit 128 of FIG. 24 by a movement 226 parallel to a prestress plane 228, the prestress plane 228 is aligned orthogonally to the longitudinal axis 106. However, the prestress plane 228 is aligned orthogonally to the longitudinal axis 106.

### LIST OF REFERENCE SIGNS

sealing arrangement 100

force transmission element 103

shaft 104

surface contact area 105

longitudinal axis 106

rotational axis 107

sealing element 108

force transmission arrangement 110

bearing 112

surface 114

outer surface 116

delimiting element 118

first zone 120

second zone 122

lubrication zone 124

discharge contact zone 126

discharge unit 128

sealing unit 130

alignment portion 131

outer carrier element 132

barrier element 134

discharge arrangement 136

bearing zone 138

lubricant 140

bearing element 142

first lubricant layer 144

second lubricant layer 146

discharge element 150

discharge contact area 152

discharger 153

first discharge element 154

outer edge 155

intermediate area

156

discharge area 157

second discharge element 158

recess area 159

receiving zone 160

receiving recess 162

center point 163

fixing element 164

separation element 166

first separation component 167

first alignment portion 168

second separation component 169

second alignment portion 170

deep-drawn separation component 171

retaining element 172

radial extent portion 173

separation portion 174

separation portion thickness 176

alignment portion thickness 178

discharge element alignment portion 180

sealing element alignment portion 182

pressing element 184

spring plate 186

first delimiting element 188

rotated delimiting element 189

second delimiting element 190

shaped delimiting element 191

first sealing element 192

rotated sealing element 193

second sealing element 194

shaped sealing element 195

third zone 196

further lubrication zone 198

outlet zone 200

discharge material 202

body

204

composite body 206

connecting material 208

inner surface 212

contact element 214

component 216

inner carrier element 218

O-ring 220

recess 222

hollow cylindrical gap 224

movement 226

prestress plane 228

sealing surface 230

first spiral groove 232

second spiral groove

234

1. A discharge unit for arrangement on a movable force transmission element which extends along a longitudinal axis or for arrangement on a shaft of which the rotational axis forms the longitudinal axis, the discharge unit comprising:
a discharge element, wherein
the discharge unit either comprises:
- an outer carrier element, wherein the discharge element fastened to the outer carrier element and extending in a direction towards the longitudinal axis and/or radially inwardly, or
- an inner carrier element, wherein the discharge element fastened to the inner carrier element and extending in a direction away from the longitudinal axis and/or radially outwardly.

2. The discharge unit as claimed in claim 1,
wherein
the discharge unit either comprises:
- a delimiting element fastened to the outer carrier element and extending in the direction towards the longitudinal axis and/or radially inwardly, which, when the discharge unit is arranged on the force transmission element, separates a first zone or lubrication zone of the outer surface of the force transmission element from a second zone or discharge contact zone of the outer surface of the force transmission element,
or the discharge unit comprises the following:
- a delimiting element fastened to the inner carrier element and extending in the direction away from the longitudinal axis and/or radially outwardly, which, when the discharge unit is arranged on the force transmission element, delimits a first zone or lubrication zone of the inner surface of a surrounding contact element from a second zone or discharge contact zone of the inner surface of the contact element.

3. The discharge unit as claimed in claim 2,
wherein
the delimiting element is a sealing element or an annular sealing element,
or the discharge unit is a sealing unit.

4. The discharge or sealing unit as claimed in claim 3,
wherein
the sealing element or the annular sealing element has a sealing surface, wherein the sealing surface is located on the outer surface or the inner surface when the discharge or sealing unit is arranged,
wherein a sealing contact between the sealing surface and the outer surface or between the sealing surface and the inner surface is a dynamic sealing contact,
wherein the sealing surface has a lubricant retention structure,
wherein the lubricant retention structure in the region of the dynamic sealing contact is capable of counteracting undesirable leakage of lubricant at least in one
direction of rotation of the force transmission element or the shaft,
and/or
the lubricant retention structure comprises a swirl structure or a spiral groove is formed in the sealing surface.

5. The discharge unit as claimed in claim 1,
wherein
the discharge element is annular.

6. The discharge unit as claimed in claim 1,
wherein
the discharge element comprises at least one discharge contact area extending in the direction of the longitudinal axis and/or radially inwardly, which can be brought into electrical contact with the outer surface of the force transmission element when the discharge unit is arranged on the force transmission element, or
the discharge element comprises at least one discharge contact area extending in the direction away from the longitudinal axis and/or radially outwardly, which can be brought into electrical contact with the inner surface of the contact element when the discharge unit is arranged on the contact element.

7. The discharge unit as claimed in claim 1,
wherein
the discharge element comprises a plurality of discharge contact areas spaced apart from one another.

8. The discharge unit as claimed in claim 2,
wherein
- the discharge unit either comprises:
- the outer carrier element,
- the discharge element fastened to the outer carrier element and extending in the direction towards the longitudinal axis and/or radially inwardly, and
the delimiting element fastened to the outer carrier element and extending in the direction of the longitudinal axis and/or radially inwardly, which, when the discharge unit is arranged on the force transmission element, delimits the first zone of the outer surface of the force transmission element from the second zone of the outer surface of the force transmission element, or the delimiting element is or comprises a textile sheet material,
or the discharge element comprises a plurality of spaced-apart discharge contact areas, wherein the plurality of spaced-apart discharge contact areas of the discharge element can be brought into electrically conductive contact with the outer surface of the force transmission element when the discharge unit on the force transmission element can be brought into electrically conductive contact with the outer surface of the force transmission element;
or the discharge unit comprises:
- the inner carrier element,
- the discharge element fastened to the inner carrier element and extending in the direction away from the longitudinal axis and/or radially outwardly, and
- the delimiting element fastened to the inner carrier element and extending in the direction away from the longitudinal axis and/or radially outwardly, which, when the discharge unit is arranged on the force transmission element, delimits the first zone of the inner surface of the surrounding contact element from the second zone of the inner surface of the contact element when the discharge unit is arranged on the force transmission element, wherein it may be advantageous if the delimiting element is or comprises a textile sheet material,
or the discharge element comprises a plurality of discharge contact areas spaced apart from one another, wherein the plurality of discharge contact areas of the discharge element spaced apart from one another can be brought into electrically conductive contact with the inner surface of the contact element when the discharge unit on the force transmission element.

9. The discharge unit as claimed in claim 2,
wherein
the discharge element is a first discharge element and the delimiting element or a further discharge element comprised by the discharge unit is a second discharge element,
wherein the second discharge element and the first discharge element extend in the same direction,
or
the first and second discharge element are each a discharge element extending in the direction towards the longitudinal axis and/or radially inwardly,
or
the first and second discharge element are each a discharge element extending in the direction away from the longitudinal axis and/or radially outwardly.

10. The discharge unit as claimed in claim 9,
wherein
the at least one discharge contact area of the first discharge element is at least one first discharge contact area and the second discharge element comprises at least one second discharge contact area, wherein the first and second discharge contact areas both extend either
- in the direction towards the longitudinal axis and/or radially inwardly
or
- away from the longitudinal axis and/or radially outwardly.

11. The discharge unit as claimed in claim 9,
wherein
at least one intermediate region of a discharge element, or at least one first intermediate region of the first discharge element, at least partially overlaps with a discharge contact area of a further discharge element, or with a discharge contact area of the second discharge element or with the second discharge contact area.

12. The discharge unit as claimed in claim 1,
wherein
the discharge unit comprises a pressing element or a spring plate, with which at least one discharge element of the discharge unit or a discharge contact area of the discharge element, is pressed against the force transmission element when the discharge unit is arranged on the force transmission element
- to the outer surface of the force transmission element, or
- pressable onto the inner surface of the contact element.

13. The discharge unit as claimed in claim 1,
wherein
- a contact force measurable orthogonally to the outer surface of the force transmission element, with which a discharge element is held in electrical contact with the outer surface of the force transmission element when the discharge unit is arranged on the force transmission element when the discharge unit is arranged on the force transmission element is at least 15 mN, when a smallest inner diameter of the discharge element is increased by one millimeter starting from a non-prestressed basic state of the discharge element when the discharge unit is arranged on the force transmission element
or
- a contact force measurable orthogonally to the inner surface of the contact element , with which a discharge element can be held in electrical contact with the inner surface of the contact element when the discharge unit is arranged on the contact element when the discharge unit is arranged on the contact element is at least 10 mN when a largest outer diameter of the discharge element is reduced by one millimeter starting from a non-prestressed basic state of the discharge element when the discharge unit is arranged on the contact element.

14. The discharge unit as claimed in claim 1,
wherein
at least one discharge element and/or at least one delimiting element and/or at least one sealing element is formed, elastically deformed and/or prestressed by means of an inclined alignment portion of the discharge unit,
or the at least one discharge element and/or the at least one delimiting element and/or the at least one sealing element is deformed, elastically deformed and/or prestressed by means of an inclined alignment portion of the discharge unit and by means of the pressing element,
or the at least one discharge element and/or the at least one delimiting element and/or the at least one sealing element is/are reshaped, elastically deformed and/or prestressed between an inclined alignment portion and the pressing element.

15. The discharge unit as claimed in claim 1,
wherein
at least one discharge element is a composite element or comprises a composite element, wherein the composite element comprises a discharge material and a reinforcing material.

16. The discharge unit as claimed in claim 1,
wherein
the discharge element is a composite element or comprises a composite element, wherein the composite element comprises a discharge material and a reinforcing material.

17. The discharge unit as claimed in claim 15,
wherein
- the discharge material is metal wool and the reinforcing material is a plastic;
and/or
- the reinforcing material comprises two plastic layers and the discharge material extends between the two plastic layers.

18. The discharge unit as claimed in claim 2,
wherein
the discharge unit comprises:
- the delimiting element extending in the direction towards the longitudinal axis and/or radially inwardly, which is a first delimiting element, and
- a second delimiting element which also extends in the direction of the longitudinal axis and/or radially inwardly,
or the discharge unit comprises:
- the delimiting element extending in the direction away from the longitudinal axis and/or radially outwardly, which is a first delimiting element, and
- a second delimiting element which also extends away from the longitudinal axis and/or radially outwardly.

19. The discharge unit as claimed in claim 2,
wherein
the discharge element and the delimiting element extend from an outlet zone of the discharge unit,
or at least a portion of the discharge element, at least a portion of the delimiting element, and at least a portion of the outlet zone are formed by an electrically conductive body containing at least one discharge material, which can, function as the carrier element or can, be arranged on the carrier element, or
wherein, at least part of the second delimiting element may also be formed by the body,
wherein the body may be a composite body comprising a discharge material and a bonding material, wherein the discharge material may be embedded in the bonding material.

20. A discharge arrangement or sealing arrangement, wherein the discharge or sealing arrangement comprises:
- a movable force transmission element extending along a longitudinal axis or a shaft of which the rotational axis forms the longitudinal axis, and/or a contact element,
- a discharge element which is in electrical contact or in sliding contact, with an outer surface of the force transmission element or with an inner surface of the contact element,
and
- a delimiting element which demarcates a first zone of the outer surface of the force transmission element from a second zone of the outer surface of the force transmission element or delimits a first zone of the inner surface of the contact element from a second zone of the inner surface of the contact element,
wherein the first zone is a lubrication zone and the second zone is a discharge contact zone.
wherein
the discharge arrangement or sealing arrangement comprises a discharge unit
wherein
the discharge unit either comprises:
- an outer carrier element, and
- the discharge element is fastened to the outer carrier element and extending in a direction towards the longitudinal axis and/or radially inwardly,
or the discharge unit comprises:
- an inner carrier element, and
- the discharge element is fastened to the inner carrier element and extending in a direction away from the longitudinal axis and/or radially outwardly,
wherein the discharge unit comprises the discharge element in electrical contact or in sliding contact with the outer surface or the inner surface and wherein the discharge unit, or comprises the delimiting element which delimits the first zone from the second zone.
